(19) United States
(12) Patent Application Publication
(10) Pub. No.: US 2025/0031191 A1
(43) Pub. Date: Jan. 23, 2025

(54) Wireless audio data transmission method and related device

(71) Applicant: NANJING ZGMICRO COMPANY LIMITED, Nanjing (CN)

(72) Inventor: Bin XU, Wuxi (CN)

(73) Assignee: NANJING ZGMICRO COMPANY LIMITED, Nanjing (CN)

(21) Appl. No.: 18/774,055

(22) Filed: Jul. 16, 2024

(30) Foreign Application Priority Data
Jul. 17, 2023 (CN) 2023108786948
Aug. 8, 2023 (CN) 2023109941090
Nov. 14, 2023 (CN) 2023115176744

(51) Int. Cl. H04W 72/0446; H04R 3/00; H04W 84/20

(52) U.S. Cl. CPC H04W 72/0446; H04R 3/00; H04R 2420/07; H04W 84/20

(57) ABSTRACT

The present invention provides a wireless audio data transmission method and related device. A master device transmits a control packet to N slave devices when the master device fails to receive an audio data packet sent by a first target device being one of N slave devices, or fails to send the audio data packet to a second target device being one of the N slave devices in a first sub-event of one isochronous interval. The control packet indicates at least one third time slot within a second sub-event of the one isochronous interval in which the first target device is permitted to transmit the audio data packet to the master device, and/or at least one fourth time slot in the second sub-event in which the second target device is permitted to receive the audio data packet transmitted by the master device. The time slots can be used for both receiving audio data packets and transmitting audio data packets, so that agile multiplexing of time slot resources between audio input slave devices and audio output slave devices can be realized, and link efficiency and transmission reliability during transmission of audio data streams can be improved.

### CROSS-REFERENCE OF RELATED APPLICATIONS

The present invention claims priorities of Chinese Patent Application No. 2023108786948 filed in China on Jul. 17, 2023, Chinese Patent Application No. 2023109941090 filed in China on Aug. 8, 2023, and Chinese Patent Application No. 2023115176744 filed in China on Nov. 14, 2023, the entire contents of which are incorporated herein by reference.

### BACKGROUND OF THE INVENTION

### Field of the Invention

The present invention relates to the technical field of wireless audio, and specifically relates to a wireless audio data transmission method and a related device.

### Description of the Related Art

In Bluetooth Low Energy (BLE) audio applications, an existing technology uses isochronous channel protocols, i.e., a Connected Isochronous Stream (CIS) link for point-to-point communication, a Connected Isochronous Group (CIG) protocol consisting of multiple CIS links, a Broadcast Isochronous Stream (BIC) protocol for point-to-multipoint communication and a Broadcast Isochronous Group (BIG) protocol consisting of multiple BIS links, to provide wireless audio services to a user. For example, a Multiple Input Multiple Output (MIMO) wireless audio system composed of wireless multi-microphones and wireless multi-channel audio devices is implemented using a hybrid CIG link composed of multiple unidirectional or bidirectional CIS links.

It is found that the link efficiency of the MIMO wireless audio system implemented by multiple bidirectional CIS links or multiple unidirectional CIS links is low in many applications.

### SUMMARY OF THE INVENTION

One of the purposes of the present invention is to provide a wireless audio data transmission method and a related device, which are used to solve a technical problem of low link efficiency in the prior art.

According to one aspect of the present invention, a wireless audio data transmission method is applied to a master device communicating wirelessly with N slave devices in consecutive isochronous intervals based on N communication links respectively, the N slave devices comprise one or more audio input slave devices and/or one or more audio output slave devices, N being an integer greater than or equal to 2. One of consecutive isochronous intervals comprises a plurality of sub-events. One sub-event includes a plurality of time slots for audio data transmission. Each time slot for audio data transmission can be used for both receiving an audio data packet and transmitting an audio data packet. The wireless audio data transmission method comprises: receiving the audio data packet transmitted by a first target device within at least one first time slot of a first sub-event, and/or, transmitting the audio data packet to a second target device within at least one second time slot of the first sub-event, wherein the first target device is one audio input slave device of the N slave devices and the second target device is one audio output slave device of the N slave devices; transmitting a control packet to the N slave devices in an event of a failure to receive the audio data packet transmitted by the first target device in the first sub-event, and/or, in an event of a failure to transmit the audio data packet to the second target device, the control packet being configured to indicate at least one third time slot within a second sub-event in which the first target device is permitted to transmit the audio data packet to the master device through corresponding communication link, and/or at least one fourth time slot in the second sub-event in which the second target device is permitted to receive the audio data packet transmitted by the master device through corresponding communication link. The first sub-event and the second sub-event are different sub-events within one isochronous interval and the second sub-event is later than the first sub-event.

According to another aspect of the present invention, a wireless audio data transmission method is provided. The wireless audio data transmission method is applied to a slave device communicating wirelessly with a master device in consecutive isochronous intervals based on a communication link. The slave device is an audio input slave device or an audio output slave device, one of consecutive isochronous intervals comprises a plurality of sub-events, one sub-event comprises a plurality of time slots for audio data transmission. Each time slot for audio data transmission is able to be used for both receiving an audio data packet and transmitting an audio data packet. The wireless audio data transmission method comprises: transmitting an audio data packet to the master device within at least one first time slot of a first sub-event when the slave device is the audio input slave device, or, receiving an audio data packet transmitted by the master device within at least one second time slot of the first sub-event when the slave device is an audio output slave device; receiving a control packet transmitted by the master device, the control packet being configured to indicate at least one third time slot within a second sub-event in which the slave device is permitted to transmit the audio data packet to the master device through corresponding communication link, or, at least one fourth time slot in which the slave device is permitted to receive the audio data packet transmitted by the master device through corresponding communication link; transmitting the audio data packet to the master device in the at least one third time slot of the second sub-event based on the control packet, or, receiving the audio data packet transmitted by the master device in the at least one fourth time slot of the second sub-event based on the control packet. The first sub-event and the second sub-event are different sub-events within the consecutive isochronous intervals and the second sub-event is later than the first sub-event.

According to another aspect of the present invention, a wireless audio data transmission device is provided. The wireless audio data transmission device is used as a master device communicating wirelessly with N slave devices in consecutive isochronous intervals based on N communication links respectively. The N slave devices comprise one or more audio input slave devices and/or one or more audio output slave devices, N being an integer greater than or equal to 2. One of consecutive isochronous intervals comprises a plurality of sub-events, and one sub-event comprises a plurality of time slots for audio data transmission. Each time slot for audio data transmission is able to be used for both receiving an audio data packet and transmitting an audio data packet. The wireless audio data transmission device comprises: a first transmission module configured for receiving the audio data packet transmitted by a first target device within at least one first time slot of a first sub-event, and/or, transmitting the audio data packet to a second target device within at least one second time slot of the first sub-event, wherein the first target device is one audio input slave device of the N slave devices and the second target device is one audio output slave device of the N slave devices; a control module configured for transmitting a control packet to the N slave devices in an event of a failure to receive the audio data packet transmitted by the first target device in the first sub-event, and/or, in an event of a failure to transmit the audio data packet to the second target device, the control packet being configured to indicate at least one third time slot within a second sub-event in which the first target device is permitted to transmit the audio data packet to the master device through corresponding communication link, and/or at least one fourth time slot in the second sub-event in which the second target device is permitted to receive the audio data packet transmitted by the master device through corresponding communication link. The first sub-event and the second sub-event are different sub-events within the consecutive isochronous intervals and the second sub-event is later than the first sub-event.

According to another aspect of the present invention, a wireless audio data transmission method is provided. The wireless audio data transmission method comprises: transmitting, by a master device communicating wirelessly with a plurality of slave devices in consecutive isochronous intervals based on a plurality of communication links respectively, a control packet to the plurality of slave devices in one sub-event, wherein one isochronous interval comprises a plurality of sub-events, one sub-event comprises a plurality of time slots for audio data transmission, the control packet comprises a block resource allocation table configured by the master device depending on requirement, the time slots in the sub-event are flexibly allocated to the slave devices according to the block resource allocation table of the control packet; and transmitting one or more audio data packets or receiving one or more audio data packets on the time slots in the one sub-event according to the block resource allocation table of the control packet.

In the present invention, in a MIMO wireless audio system, the time slots for audio data transmission can be used for both receiving the audio data packet and transmitting the audio data packet, so as to realize agile multiplexing of time slot resources between the audio input slave devices and the audio output slave devices. Therefore, when the audio transmission of the audio input slave device and/or the audio output slave device fails in a certain sub-event, the time slot resources of the audio input slave device and/or the audio output slave device that fails in the audio transmission can be flexibly adjusted in the subsequent sub-event, so as to increase the probability that the audio input slave device and/or the audio output slave device successfully completes the audio transmission in the subsequent sub-event, so that the defect caused by fixed allocation of time slot resources in the prior art can be avoided, and link efficiency and transmission reliability of the MIMO wireless audio system can be improved.

There are many other objects, together with the foregoing attained in the exercise of the invention in the following description and resulting in the embodiment illustrated in the accompanying drawings.

### BRIEF DESCRIPTION OF THE DRAWINGS

These and other features, aspects, and advantages of the present invention will become better understood with regard to the following description, appended claims, and accompanying drawings wherein:

FIG. 1 is a schematic diagram of a wireless audio data transmission method according to one embodiment of the present invention;

FIG. 2 is a schematic diagram of an AMIMO wireless audio system according to one embodiment of the present invention;

FIG. 3 is a schematic diagram of a header of an AISM PDU according to one embodiment of the present invention;

FIG. 4 is a schematic diagram of a header of an AISD PDU according to one embodiment of the present invention;

FIG. 5 is a schematic diagram of a payload according to one embodiment of the present invention;

FIG. 6 is a schematic diagram of a synchronization control data packet according to one embodiment of the present invention;

FIG. 7 is a schematic diagram of a link information according to one embodiment of the present invention;

FIG. 8 is a schematic diagram of a control command according to one embodiment of the present invention;

FIG. 9(a) is a schematic diagram of an AIS random access command according to one embodiment of the present invention;

FIG. 9(b) is a schematic diagram of an AIS access request according to one embodiment of the present invention;

FIG. 9(c) is a schematic diagram of an AIS access permit command according to one embodiment of the present invention;

FIG. 9(d) is a schematic diagram of an AIS terminate command according to one embodiment of the present invention;

FIG. 10 is a schematic diagram of another wireless audio data transmission method according to one embodiment of the present invention;

FIG. 11(a) is a schematic diagram of a time slot allocation scheme according to one embodiment of the present invention;

FIG. 11(b) is a schematic diagram of another time slot allocation scheme according to one embodiment of the present invention;

FIG. 12 is a schematic flow chart of an AMIMO slave device accessing an AIG to establish an AIS link according to one embodiment of the present invention;

FIG. 13 is a schematic diagram of a wireless audio data transmission device according to one embodiment of the present invention;

FIG. 14 is a schematic diagram of another wireless audio data transmission device according to one embodiment of the present invention;

FIG. 15 is a schematic structural diagram of an AMIMO audio device according to one embodiment of the present invention; and

FIG. 16 is a schematic structural diagram of an electronic device according to one embodiment of the present invention.

### DETAILED DESCRIPTION OF THE PREFERRED EMBODIMENTS

The detailed description of the invention is presented largely in terms of procedures, operations, logic blocks, processing, and other symbolic representations that directly or indirectly resemble the operations of data processing devices that may or may not be coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be comprised in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

In a related art, a Multiple Input Multiple Output (MIMO) wireless audio system with multiple wireless microphones and wireless multi-channel audio devices is implemented by using a hybrid CIG link including a plurality of unidirectional or bidirectional CIS links. For example, a two-channel True Wireless Stereo (TWS) headset application with microphone based on two bidirectional CIS links is a typical wireless audio system with two inputs and two outputs consisting of a TWS headset with microphone and a smartphone. As another example, a dual wireless microphone realized by two unidirectional CIS links and a dual-channel TWS headset application realized by two unidirectional CIS links are also a typical wireless audio system with two inputs and two outputs consisting of the dual wireless microphone and the dual-channel TWS headset with a smartphone. Still in another example, a wireless audio entertainment system consisting of a dual wireless microphone implemented by two unidirectional CIS links and wireless multi-channel speakers implemented by four unidirectional CIS links is also a typical wireless audio system with two inputs and four outputs consisting of the dual wireless microphone and the wireless four-channel speakers with an audio entertainment center device.

It is found that link efficiency of the MIMO wireless audio system realized by multiple bidirectional CIS links or multiple unidirectional CIS links is low when an audio data stream is transmitted. Specifically, if an audio input function or an audio output function is supported based on a plurality of unidirectional CIS links, in order to meet an audio transmission demand temporarily initiated by a user, a new CIS link needs to be re-established to provide audio transmission service, and establishment of the new CIS link is time-consuming. In addition, if the audio input function and the audio output function are simultaneously supported based on a plurality of bidirectional CIS links, the time slots corresponding to the audio input function and the audio output function are respectively fixed. If the audio input or the audio output is not required at the current moment (i.e., successful transmission of an audio data packet or successful reception of an audio data packet), it can only wait for the corresponding time slots to be consumed unnecessarily, which results in a great waste of time slot resources.

In response to the above problem, the present invention proposes a wireless audio data transmission system (or referred to as Almighty Multiple Input Multiple Output (AMIMO) wireless audio system). The AMIMO system comprises a master device and a plurality of slave devices, wherein the master device communicates wirelessly with the slave devices based on a plurality of communication links in consecutive isochronous intervals, and the slave devices comprises one or more audio input slave devices and one or more audio output slave devices.

The present invention also provides a wireless audio data transmission method, wherein the AMIMO system employs an agile isochronous stream (AIS) link protocol implemented based on the wireless audio data transmission method provided in the present invention, and an agile isochronous group (AIG) link protocol comprising at least two AIS links. Each time slot used for audio data transmission is set to be used for both receiving audio data packets and transmitting audio data packets, so as to realize agile multiplexing of time slot resources between the one or more audio input slave devices and the one or more audio output slave devices, and to improve ability of a plurality of audio input links and a plurality of audio output links to adapt to changes in the wireless channel. Thereby, under the condition that the audio transmission of the audio input slave device and/or the audio output slave device fails in a certain sub-event, an agile adjustment of the time slot resources, in the subsequent sub-event, of the audio input slave device and/or the audio output slave device which fail in the audio transmission is supported. Therefore, the probability that the audio input slave device and/or the audio output slave device successfully complete the audio transmission in the subsequent sub-events is increased, the defects caused by the fixed configuration of the time slot resources in the related technology are further avoided, and the link efficiency and the transmission reliability of the MIMO wireless audio system during the audio data stream transmission are improved.

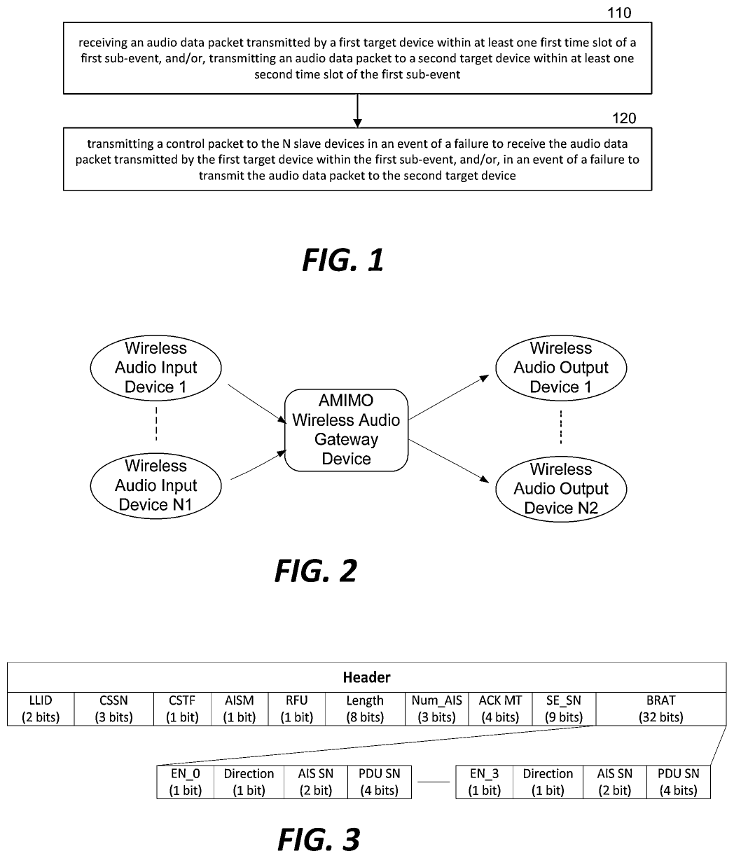

As shown in FIG. 1, a master device communicates wirelessly with N slave devices in consecutive isochronous intervals based on N communication links respectively. The N slave devices comprise one or more audio input slave devices and one or more audio output slave devices, and N is an integer greater than or equal to 2.

In the present invention, a communication time for the master device to communicate wirelessly with the N slave devices based on the N communication links respectively is divided into a plurality of consecutive isochronous intervals. One isochronous interval comprises a plurality of sub-events (SE). One sub-event comprises a plurality of time slots for audio data transmission. Each time slot for audio data transmission may be used for receiving an audio data packet and transmitting an audio data packet. The wireless audio data transmission method applied to the master device comprises following operations.

At 101, the master receives an audio data packet transmitted by a first target device within at least one first time slot of a first sub-event, and/or, transmits an audio data packet to a second target device within at least one second time slot of the first sub-event. The first target device is one audio input slave device of the N slave devices and the second target device is one audio output slave device of the N slave devices.

The first sub-event is one sub-event within one of the plurality of isochronous intervals. The at least one first time slot in the first sub-event is allocated by the master device for the first target device, and is used for the first target device to transmit the audio data packet. Accordingly, the master device receives the audio data packet transmitted by the first target device within the at least one first time slot. Similarly, the at least one second time slot in the first sub-event is allocated by the master device for the second target device, and is used for the second target device to receive the audio data packet. Accordingly, the master device transmits the audio data packet to the second target device within the at least one second time slot. It is to be understood that, as a specific embodiment, the master device may transmit a control packet to the slave devices so as to inform all the slave devices of allocation of the time slot resource of each slave device.

Exemplarily, the master device may be a smartphone, a personal computer, a tablet computer, a smart TV, an audio entertainment device, a wireless game console, and the like. The audio input slave device may be a wireless microphone, a wireless audio source device or a musical instrument, etc. The audio output slave device may be a wireless headphone or a wireless speaker and the like. It should be noted that the audio input slave device and the audio output slave device may also be a device that simultaneously supports a wireless audio input function and a wireless audio output function, such as a headset.

Referring now to FIG. 2, which illustrates an AMIMO wireless audio system. The AMIMO wireless audio system comprises an AMIMO wireless audio gateway device (i.e., the master device) and N1 wireless audio input devices (i.e., the audio input slave devices) and N2 wireless audio output devices (i.e., the audio output slave devices), wherein N1 and N2 are greater than or equal to 0, and the sum N of N1 and N2 N is not less than 2. In one example, the AMIMO wireless audio system can be formed based on a smartphone acting as the AMIMO wireless audio gateway device, two independent wireless microphones acting as the wireless audio input devices, and one TWS headset comprising two independent wireless mono headphones and acting as the wireless audio output devices.

The AMIMO wireless audio gateway device connects with each wireless audio input device or each wireless audio output device via an agile isochronous stream (AIS) link to transmit audio data. The AIS links established between the AMIMO wireless audio gateway device and all the wireless audio input devices or wireless audio output devices constitutes an agile isochronous group (AIG) link. The AMIMO wireless audio gateway device may be referred to as an AIS master device or an AIG master device or an AMIMO master device, and all the wireless audio input devices or wireless audio output devices may be referred to as AIS slave devices or AIG slave devices or AMIMO slave devices.

At 102, the master device transmits a control packet to the N slave devices in the event of a failure to receive the audio data packet transmitted by the first target device in the first sub-event, and/or, in the event of a failure to transmit the audio data packet to the second target device. The control packet is configured to indicate at least one third time slot within a second sub-event in which the first target device is permitted to transmit the audio data packet to the master device through corresponding communication link, and/or at least one fourth time slot in the second sub-event in which the second target device is permitted to receive the audio data packet transmitted by the master device through corresponding communication link.

The first sub-event and the second sub-event are different sub-events within one isochronous interval and the second sub-event is later than the first sub-event. The first time slot, the second time slot, the third time slot, and the fourth time slot are the time slots used for audio data transmission. A time slot distribution of the at least one first time slot in the first sub-event is different from a time slot distribution of the at least one third time slot in the second sub-event, and/or, a time slot distribution of the at least one second time slot in the first sub-event is different from a time slot distribution of the at least one fourth time slot in the second sub-event.

Specifically, in the event that the master device fails to receive the audio data packet transmitted by the first target device in the first sub-event, then the control packet will indicate the at least one third time slot in the second sub-event in which the first target device is permitted to transmit the audio data packet to the master device through corresponding communication link. Similarly, in the event that the master device fails to transmit the audio data packet to the second target device in the first sub-event, the control packet will indicate the at least one fourth time slot in the second sub-event in which the second target device is permitted to receive the audio data packet transmitted by the master device through corresponding communication link.

Correspondingly, in the event that the master device fails to receive the audio data packet transmitted by the first target device in the first sub-event and the master device fails to transmit the audio data packet to the second target device in the first sub-event, the control packet will indicate the at least one third time slot in the second sub-event in which the first target device is permitted to transmit the audio data packet to the master device through corresponding communication link, and the at least one fourth time slot in the second sub-event in which the second target device is permitted to receive the audio data packet transmitted by the master device through corresponding communication link.

The difference between the time slot distribution of the at least one first time slot in the first sub-event and the time slot distribution of the at least one third time slot in the second sub-event comprises: when the number of first time slots and the number of third time slots are the same, a time slot order of the at least one first time slot in the first sub-event and the time slot order of the at least one third time slot in the second sub-event interval are at least partially different, e.g., the time slots 1, 2, and 3 are the first time slots in the first sub-event, and the time slots 2, 4, and 6 are the third time slots in the second sub-event; or, the number of first time slots and the number of third time slots are different, e.g., the time slot 1 is the first time slot in the first sub-event, while the time slots 1, 3 are the third time slots in the second sub-event.

The difference between the time slot distribution of the at least one second time slot in the first sub-event and the time slot distribution of the at least one fourth time slot in the second sub-event comprises: the time slot order of the at least one second time slot in the first sub-event and the time slot order of the at least one fourth time slot in the second sub-event are at least partially different when the number of second time slots and the number of fourth time slots are the same, or, the number of second time slots and the number of fourth time slots are different.

It is noted that each time slot in the consecutive isochronous intervals be able to be used for receiving the audio data packet and transmitting the audio data packet. Therefore, when the audio input slave device and/or the audio output slave device fails to perform audio transmission in one sub-event, the time slot resources of the device whose audio transmission failed may be adjusted within the subsequent sub-event (e.g., the time slot resource originally allocated to the audio output slave device is allocated to the audio input slave device, the time slot resource originally allocated to the audio input slave device is allocated to the audio output slave device, the time slot resource originally allocated to a certain audio input slave device is allocated to another audio input slave device, the time slot resource originally allocated to a certain audio output slave device is allocated to another audio output slave device, and so on), so as to increase the probability of successful audio transmission of the device whose audio transmission failed.

It is to be understood that, in the present invention, the master device may also allocate the same time slot resources for one slave device in both the first sub-event and the second sub-event according to a specific application scenario. At this time, the time slot order and the number of time slots comprised in the time slot resources of the slave device in the first sub-event is the same as the time slot order and the number of time slots comprised in the time slot resources of the slave device in the second sub-event, e.g., the time slots of the slave device in the first sub-event is time slots 1, 3, and the time slots 1, 3 in the second sub-even may still be allocated to the slave device in order to satisfy audio retransmission requirement.

It is to be noted that in the present invention, when the audio input slave device or the audio output slave device still does not successfully transmit or receive corresponding audio data packet in the second sub-event, a new control packet may be transmitted to the audio input slave device or the audio output slave device, in order to allocate corresponding time slot resource for the audio input slave device or the audio output slave device in the subsequent sub-event after the second sub-event, such that the audio input slave device or the audio output slave device continues to transmit the audio data packet or receive the audio data packet. The details of how to allocate the corresponding time slot resources for the audio input slave device or the audio output slave device in the subsequent sub-events can be found in the time slot allocation in the second sub-event corresponding to the first target device or the second target device, and will not be repeated here to avoid repetition.

In one embodiment, the number of the at least one third time slot is greater than the number of the at least one first time slot, and/or, the number of the at least one fourth time slot is greater than the number of the at least one second time slot. In this embodiment, setting the number of the at least one third time slot greater than the number of the at least one first time slot can increase the probability of successful audio retransmission of the first target device by increasing the number of time slots allocated for the first target device in the second sub-event in case that the first target device fails to perform audio transmission in the first sub-event, and improve communication quality of the audio data stream during transmission. Similarly, setting the number of at least one fourth time slot greater than the number of the at least one second time slot also increases the probability of successful audio retransmission of the second target device.

In another embodiment, any one of the time slots comprised in the second sub-event may be determined as the third time slot or the fourth time slot. In one example, an idle time slot among the plurality of time slots comprised in the second sub-event may be determined as the third time slot or the fourth time slot to further enhance the link efficiency of the MIMO wireless audio system during transmission of the audio data stream. The idle time slot may be understood as a time slot corresponding to the slave device that successfully performs audio transmission in the first sub-event. For example, if the slave device corresponding to the time slot 1 successfully performs the audio transmission in the first sub-event, the time slot 1 may be determined as one idle time slot in the second sub-event.

In one embodiment, in the event that the master device successfully receives the audio data packet transmitted by the first target device in the first sub-event, the first target device is prohibited from transmitting the audio data packet to the master device through corresponding communication link in the second sub-event. In the event that the master device successfully transmits the audio data packet to the second target device in the first sub-event, the second target device is prohibited from receiving the audio data packet transmitted by the master device through corresponding communication link in the second sub-event.

In this embodiment, when the audio input slave device or the audio output slave device successfully completes audio transmission in a certain sub-event, the corresponding audio input slave device or the audio output slave device is prohibited from performing the audio transmission in the subsequent sub-event in order to avoid repeated transmission of the audio data packet. At the same time, the corresponding time slots in the subsequent sub-event may be converted to the idle time slots for use, and agile allocation of time slot resources is realized by allocating the idle time slots to the audio input slave device or the audio output slave device that has not completed the audio transmission.

Exemplarily, when the time slot for the communication link corresponding to the first target device is not allocated in the second sub-event, it can be considered that the first target device is prohibited from transmitting the audio data packet to the master device through corresponding communication link in the second sub-event. Similarly, when the time slot for the communication link corresponding to the second target device is not allocated in the second sub-event, it can be considered that the second target device is prohibited from receiving the audio data packet transmitted by the master device through corresponding communication link.

In one embodiment, the control packet comprises a link sequence, wherein the link sequence comprises at least one first element indicating the communication link corresponding to the first target device, and at least one second element indicating the communication link corresponding to the second target device. An order of the at least one first element in the link sequence is configured to indicate the at least one third time slot in the second sub-event in which the first target device is permitted to transmit the audio data packet to the master device through corresponding communication link.

An order of the at least one second element in the link sequence is configured to indicate the at least one fourth time slot within the second sub-event in which the second target device is permitted to receive the audio data packet transmitted by the master device through corresponding communication link. In this embodiment, the order of the at least one first element and the order of the at least one second element in the link sequence are configured to indicate the at least one third time slot in the second sub-event in which the first target device is permitted to transmit the audio data packet to the master device through corresponding communication link, and the at least one fourth time slot within the second sub-event in which the second target device is permitted to receive the audio data packet transmitted by the master device through corresponding communication link, so that bit resource in the control packet indicating corresponding time slot of the slave device can be reduced.

The plurality of time slots indicated in the link sequence may be enabled. A value of each element of a plurality of elements comprised in the link sequence indicates a corresponding communication link, and the order of each element in the link sequence indicates corresponding time slot. Thus, the value of the first element is used to indicate corresponding communication link of the first target device, and the value of the second element is used to indicate corresponding communication link of the second target device. For example, if it is set that the link number of the communication link established between the first target device and the master device is 1, the link number of the communication link established between the second target device and the master device is 2, and the link sequence in the control packet is [1212]. The link sequence [1212] indicates that there are four enabled time slots in the second sub-event. A first time slot is allocated to the communication link numbered 1, a second time slot is allocated to the communication link numbered 2, a third time slot is allocated to the communication link numbered 1, and a fourth time slot is allocated to the communication link numbered 2.

In one embodiment, the control packet comprises a first sub-parameter and a second sub-parameter. The first sub-parameter is configured for indicating the third time slot or the fourth time slot in the second sub-event, and the second sub-parameter is configured for indicating the link number of the communication link corresponding to the first target device or the link number of the communication link corresponding to the second target device. In this embodiment, the control packet comprises a sub-parameter for indicating the time slot (e.g., the first sub-parameter) and a sub-parameter for indicating the communication link (e.g., the second sub-parameter). By setting the sub-parameters for indicating corresponding time slots and the sub-parameters for indicating corresponding communication links in the control packet, a more flexible time slot allocation scheme is provided, and ubiquity of the method described in the present invention in the course of practical application is further enhanced.

Exemplarily, if the control packet is set to comprise: S11S22S31S42. S1, S2, S3, S4 indicate a first time slot, a second time slot, a third time slot, and a fourth time slot in one sub-event, respectively. 1 and 2 indicate the communication link numbered 1 and the communication link numbered 2, respectively. If the communication link numbered 1 is the communication link corresponding to the first target device, and the communication link numbered 2 is the communication link corresponding to the second target device, then S11S22S31S42 indicates that the first time slot and the third time slot in the one sub-event are allocated to the communication link corresponding to the first target device, and the second time slot and the fourth time slot in the one sub-event are allocated to the communication link corresponding to the second target device. At this time, S1, S2, S3, and S4 may be understood to be the first sub-parameter, and 1 and 2 may be understood to be the second sub-parameter.

It is to be noted that whether the link sequence or a plurality of first sub-parameters and second sub-parameters is used, it is defaulted that the master device and the slave devices are aware of the transmission direction of corresponding communication link. That is, the transmission direction of each of the N communication links is stored or recorded in the master device, the transmission direction of corresponding communication link is stored or recorded in the slave device, and the master device and the slave device can be made to be aware of the data flow direction of the corresponding communication link based on the transmission direction. E.g., the master device transmits the audio data packet to the slave device or, alternatively, the master device receives the audio data packet transmitted by the slave device. As a specific embodiment, the communication link corresponding to each slave device and its audio data transmission direction may be determined when the slave device is accessed by the master device.

In one embodiment, a value of the first sub-parameter is configured to indicate whether the third time slot or the fourth time slot is enabled. In this embodiment, the value of the sub-parameter in the control packet can be configured to indicate whether corresponding time slot is enabled, so as to further enhance generalizability of the method of the present invention during practical application. For example, the sub-parameter corresponding to the nth time slot (referred to as: EN_n) can be set to 0 or 1, wherein 0 indicates that the nth time slot is not enabled and 1 indicates that the nth time slot is enabled.

In one embodiment, the control packet comprises a third sub-parameter and/or a fourth sub-parameter. The third sub-parameter is configured to indicate the number of the audio data packet corresponding to the first target device or the number of the audio data packet corresponding to the second target device, and the fourth sub-parameter is configured to indicate a direction of audio data transmission corresponding to the first target device or a direction of audio data transmission corresponding to the second target device.

In one embodiment, the control packet further comprises: a first identification parameter and/or a second identification parameter. The first identification parameter is configured to indicate the number of communication links wirelessly communicating with the master device, and the second identification parameter is configured to indicate a sequence number of the second sub-event in corresponding isochronous interval. In one embodiment, the control packet further comprises an acknowledgement link mapping table, the acknowledgement link mapping table is configured to indicate the communication link that is required to reply with an acknowledgement ACK.

In this embodiment, the acknowledgement link mapping table is provided in the control packet to facilitate interaction between the master device and the slave devices waiting to receive the audio data packets transmitted by the master device, is configured to direct the slave device to reply the acknowledgement to the master device via corresponding communication link after successfully receiving the audio data packet, so that the master device confirms that the audio data packet sent by the master device is successfully received by the corresponding slave device.

Compared to the way of additionally setting a request to reply with an ACK, the way of setting the acknowledgement link mapping table in the control packet has a higher utilization of communication resources and avoids overhead of additional time slot resources, which makes overall link efficiency of the wireless audio data transmission system higher as well. In one embodiment, the audio data packet comprises audio data as well as a preset parameter, wherein the preset parameter comprises at least one of the following: a fifth sub-parameter for indicating a transmission direction of the audio data packet; a sixth sub-parameter for indicating a link number of corresponding communication link; and a seventh sub-parameter for indicating the number of the audio data packet.

In one embodiment, two types of Protocol Data Units (PDUs) may be defined: one is agile isochronous stream Manager (AISM) PDU, the other is agile isochronous stream Data (AISD) PDU. The AMIMO master device mainly uses the AISM PDU as the control packet to transmit block resource allocation information or block acknowledgement. The AMIMO master device and the AMIMO slave devices transmit audio data to each other using the AISD PDU with audio payload, and can also transmit the acknowledgement using the AISD PDU without payload. The AISM PDU and a Broadcast Isochronous Stream (BIS) PDU have the same structure but different header format, i.e., an extended header of BIS PDU is used as the header of AISM PDU. The AISD PDU and a BLE Connected Isochronous Stream (BIS) PDU have the same structure but different header format, i.e., an extended header of CIS PDU is used as the header of the AISD PDU.

As shown in FIG. 3, the header of the AISM PDU is formed based on the header of the BIS PDU. 1-bit Reserved for Future Use (RFU) field of the header of BIS PDU is set to AISM field to indicate whether the AISM PDU is enabled. The AISM field is assigned to 0 to indicate that the AISM PDU is not enabled, and the AISM field is assigned to 1 to indicate that the AISM PDU is enabled. When the AISM PDU is not enabled, the AISM PDU can be understood as the BIS PDU. When the AISM PDU is enabled, compared with the header of BIS PDU, the header of the AISM PDU will increase by a certain number of bytes and contain one or more fields such as Num_AIS, ACK MT, SE_SN and BRAT. Specifically, Num_AIS indicates the number of AIS links currently established, which can be understood as the first identification parameter mentioned above.

ACK MT is configured to indicate a mapping table (MT) of the AIS audio output links that are requested to reply with an acknowledgement (ACK), which may be understood as the aforementioned acknowledgement link mapping table. Each bit of the ACK MT corresponds to one AIS audio output link or one wireless audio output device connected to the AIS audio output link. For example, the bits from low to high of the ACK MT sequentially correspond to the sequence number (SN) of the AIS link from low to high. When one bit of the ACK MT is set to 1, it indicates that the AIS link corresponding the one bit is required to reply with the acknowledgement, and when one bit is set to 0, it indicates that the AIS link corresponding the one bit is not required to reply with the acknowledgement. SE_SN represents a sequence number of a sub-event (SE) within one AIG isochronous interval (ISO Interval) or a sequence number of the AISM PDU within one AIG isochronous interval. The aforementioned second identification parameter may be understood as the sequence number corresponding to the second sub-event. BRAT represents a Block Resource Allocation Table (BRAT) and is used to allocate resource units (RUs) or time slot resources to different AIS links in bulk or block. BRAT comprises a plurality of resource allocation units. The number of resource allocation units is Num_RU. Num_RU generally corresponds to the total number of AMIMO slave devices N, or can be larger or smaller than N.

The resource allocation unit numbered n in the BRAT corresponds to the time slot resource numbered n, comprises an enable signal (EN_n), a Direction field, a sequence number AIS SN of the AIS link, and a sequence number PDU SN of the protocol data unit. EN_n may be understood as a value of the first sub-parameter as described before, and the Direction field may be understood as the fourth sub-parameter as described before. AIS SN may be understood as the aforementioned second sub-parameter, and PDU SN may be understood as the aforementioned third sub-parameter.

For example, EN_n is set to 1 to indicate that the time slot numbered n is enabled, and EN_n is set to 0 to indicate that the time slot numbered n is not enabled. When EN_n is set to 1, the Direction field is set to 0 to represent the audio output direction, i.e., the direction in which the AMIMO master device transmits AISD PDU to the wireless audio output device. The Direction field is set to 1 to represent the audio input direction, i.e. the direction in which the wireless audio input device transmits AISD PDU to the AMIMO master device. In another embodiment, the Direction can also be set as 0 to represent the audio input direction and 1 to represent the audio output direction.

When EN_n is set to 1, AIS SN in the Resource Allocation Unit with sequence number n indicates that the time slot with sequence number n is used for the AIS link with sequence number AIS SN to receive or transmit AISD PDUs. When EN_n is set to 1, PDU SN in the resource allocation unit with sequence number n indicates that the time slot numbered n are used for the AIS links with the sequence number AIS SN to transmit or receive AISD PDU with the sequence number PDU SN.

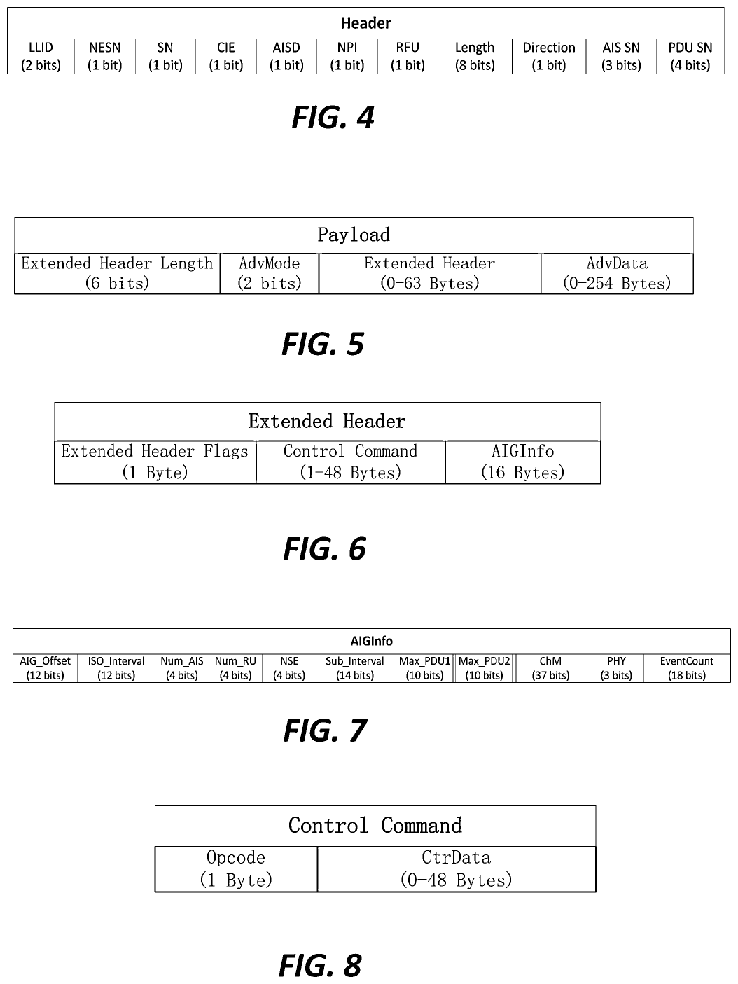

The other fields of the header of AISM PDU have the same functionality and usage as the BIS PDU, including a Logical Link Identifier (LLID) used to indicate a type of payload of AISM PDU, a Control sub-event Sequence Number (CSSN), a Control sub-event Transmission Flag (CSTF), a length of payload of AISM PDU, and 1-bit RFU. Exemplarily, as shown in FIG. 4, the header of the AISD PDU is formed based on the header of BIS PDU. 1-bit Reserved for Future Use field of BIS PDU is set to an AISM field to indicate whether the AISM PDU is enabled. The AISM field is assigned to 0 to indicate that the AISM PDU is not enabled, and the AISM field is assigned to 1 to indicate that the AISM PDU is enabled.

The header of the AISD PDU is increased by a certain number of bytes when the AISD PDU is enabled, and contains at least one or more fields such as Direction, AIS SN, or PDU SN. The Direction field can be understood as the aforementioned fifth sub-parameter, the AIS SN field can be understood as the aforementioned sixth sub-parameter, and the PDU SN field can be understood as the aforementioned seventh sub-parameter.

The Direction field represents the audio transmission direction. When the Direction field is set to 0, it represents the audio output direction, i.e., the AMIMO master device transmits the AISD PDU to the wireless audio output device. When the Direction field is set to 1, it represents the audio input direction, i.e., the wireless audio input device transmits the AISD PDU to the AMIMO master device. The AIS SN field indicates that the current sequence number of the AIS link corresponding to the AISD PDU. The PDU SN field indicates the PDU sequence number of the AIS link corresponding to the current AISD PDU.

The meanings of the other fields of the header of AISD PDU are the same as those of the header of CIS PDU. LLID is logical link identifier, which is configured to indicate a payload type of the AISD PDU. NESN is next expected sequence number. SN is current sequence number. CIE is Close Isochronous Event, which indicates whether to end the Isochronous Event. NPI is Null PDU Indicator, which indicates whether the PDU is a CIS Data PDU or a CIS Null PDU (empty PDU) in the CIS PDU, and indicates whether the PDU is an AISD Data PDU or an AISD Null PDU in the AISD PDU. AISD Null PDU is configured to carry acknowledgement, and Length denotes a payload length of the AISD PDU.

In one embodiment, the isochronous intervals further comprise a bidirectional advertising communication time slot, wherein the master device periodically transmits a synchronization control data packet based on a periodic advertising channel in the bidirectional advertising communication time slot and receives a synchronization control response packet fed back by a candidate slave device which is one of the slave devices requesting access. The master device transmits a link random access command based on the synchronization control data packet and obtains a link access request fed back by the candidate slave device requesting access based on the received synchronization control response packet. The master device determines, based on the link access request, that the candidate slave device requesting access is the audio input slave device or the audio output slave device.

The master device further transmits a link access permit command based on the synchronization control data packet for permitting the candidate slave device to establish a communication link with the master device. In this embodiment, the master and the slave devices utilize a periodic advertising mechanism to accomplish random access control of the candidate slave device based on the periodic advertising channel within the bidirectional advertising communication time slot, thereby solving problem of access difficulties of multiple input links and multiple output links in related techniques (e.g., CIG).

In one embodiment, the AIG slave device can synchronize the AIG master device and obtain AIG link information (AIGInfo) through an extended advertising (ADV_EXT_IND) protocol data unit (PDU) transmitted by the AIG master device on the primary advertising channel, an Auxiliary Advertising (AUX_ADV_IND) PDU transmitted by the AIG master device on the Secondary Advertising channel, and a Synchronization Control (AUX_SYNC_CTR) PDU transmitted by the AIG master device on the periodic advertising channel.

After the AIG slave device is synchronized to the AIG master device, the AIG slave device can establish, maintain, and revoke the AIS link with the AIG master device via the AUX_SYNC_CTR PDU and the synchronization control response (AUX_SYNC_CTR_RSP) PDU.

After the AIS link is established, the AIG slave device can receive the AISM PDUs transmitted by the AIG master device, transmits or receives AISD PDUs using the allocated time slots based on the block resource allocation information carried by the BRAT in the AISM PDUs, and determine whether to reply with the acknowledgement based on the ACK MT.

The structure of AUX_SYNC_CTR PDU and AUX_SYNC_CTR_RSP PDU is similar to that of AUX_SYNC_IND PDU, both of which use a Common Extended Advertising Payload Format (CEPF) as shown in FIG. 5. The CEPF contains 6 bits Extended Header Length, 2 bits AdvMode, 0-63 bytes Extended Header, and up to 254 bytes of AdvData. The Extended Header format of AUX_SYNC_CTR PDU and AUX_SYNC_CTR_RSP PDU is shown in FIG. 6. The Extended Header format contains one byte of Extended Header Flags to indicate whether a subsequent control command has content. If so, it also contains 1-48 bytes of Control Command, and 16 bytes of AIG link information (AIGInfo).

In one embodiment, when the master device transmits the link random access command based on the synchronization control data packet, the synchronization control data packet carries link information. The link information comprising at least one of the following: a first link parameter for indicating a time offset of a starting moment of the synchronization control data packet from a starting moment of the isochronous interval; a second link parameter for indicating a duration of the isochronous interval; a third link parameter for indicating a maximum number of the communication links allowed to be established; a fourth link parameter for indicating a maximum number of the time slots for audio data transmission that may be allocated to the slave device; a fifth link parameter for indicating the number of sub-events comprised in one isochronous interval; a sixth link parameter for indicating a time interval between two adjacent sub-events within one isochronous interval; a seventh link parameter for indicating a maximum number of bytes of a payload of a protocol data unit corresponding to the master device; an eighth link parameter for indicating a maximum number of bytes of a payload of a protocol data unit corresponding to the candidate slave device; a ninth link parameter for indicating a channel mapping table.

The link information is set to indicate a link access requirement between the candidate slave device and the master device to guide the candidate slave device to complete a link random access action with the master device. As an example, as shown in FIG. 7, the first link parameter may be defined as AIG_Offset for indicating the time between a starting moment of the AUX_SYNC_CTR PDU (i.e., the starting moment of the synchronization control data packet) and an anchor point of the AIG. The anchor point of the AIG is a starting moment of the first isochronous interval of the consecutive isochronous intervals. The second link parameter may be defined as ISO_Interval, which specifically is the isochronous interval of the AIG, i.e., the time between the starting points of two AIG events in 1.25 ms. The third link parameter may be defined as Nun_AIS, referring to the maximum number of AIS links that can be accessed by the master device, and the communication link may be understood as the AIS link. The fourth link parameter may be defined as Num_RU, referring to the maximum number of time slots that can be allocated in the aforementioned Block Resource Allocation Table (BRAT), which generally corresponds to the total number of the AMIMO slave devices, or may be more or less than the total number of the AMIMO slave devices. The fifth link parameter may be defined as NSE, referring to the number of Sub-Events in one AIG isochronous interval. The sixth link parameter can be defined as Sub_Interval, which refers to the interval between two Sub-Events. The seventh link parameter can be defined as Max_PDU1, which refers to the maximum number of bytes of the payload of the AISM PDU. The eighth link parameter can be defined as Max_PDU2, which refers to the maximum number of bytes of the payload of the AISD PDU. The ninth link parameter can be defined as ChM, which contains a channel mapping table indicating which channels are available (Used) and which channels are not used (Unused). Each channel is represented by a single bit, which is set to 1 for used, and 0 for unused. The lowest bit represents the lowest Channel Index, the highest bit represents the highest channel index. The tenth link parameter can be defined as PHY, indicating the PHY format used by the AIG. 0 means BLE 1M PHY, 1 means BLE 2M PHY, 2 means BLE Coded PHY, and other values can indicate a higher rate PHY, such as 4 Mbps PHY, 6 Mbps PHY, 6 Mbps PHY or 8 Mbps PHY etc.

According to the BLE protocol, the first 7 bits of the Extended Header Flags are set to 0. The 7th bit reserved field is defined as the Control field in the AUX_SYNC_CTR PDU and AUX_SYNC_CTR_RSP PDU and is set to 1 to represent that the extended header of the AUX_SYNC_CTR PDU and AUX_SYNC_CTR_RSP PDU contains the Control Command. The format of the Control Command is shown in FIG. 8 and comprises two parts, Opcode and CtrData. The Opcode and CtrData of different control commands are different. Three control commands for AUX_SYNC_CTR PDU are defined in one embodiment of the present invention, and include an AIS random access command, an AIS access permit command, and an AIS terminate command. One control command for AUX_SYNC_CTR_RSP PDU is defined in one embodiment of the present invention, i.e., the AIS access request. The AIS terminate command is also applicable to AUX_SYNC_CTR_RSP PDU. The AIS random access command is used for the AIG master device to open a random access window, which facilitates the AIG slave device to transmit the AIS access request to request access.

The AIG slave devices are allowed to transmit the AIS access requests only during the random access window opened by the AIG master device, and the AIG slave devices cannot transmit the AIS access requests at other times. The AIS access request is used for the AIG slave device to request access or request establishment of one AIS link when the AIG master device opens the random access window. The AIS access permit command is used for the AIG master to permit the AIG slave to access or establish one AIS link. The AIS terminate command is used for the AIG master device to terminate a particular AIS link or all the AIS links, and can also be used for the AIG slave device to request termination of corresponding AIS. According to one embodiment, it is set that Opcode of the AIS random access command=0x10, Opcode of the AIS access request=0x11, Opcode of the AIS Access Permit command=0x12, and Opcode of the AIS terminate command=0x13.

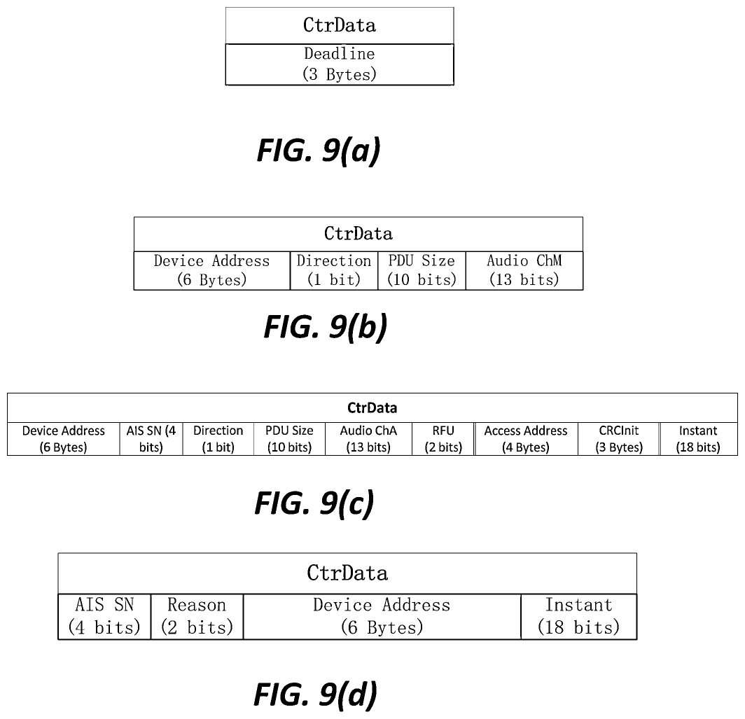

FIG. 9(a) shows the CtrData of the AIS random access command, which contains 3 bytes of Random Access Deadline, lower 18 bits of which is the same as a definition of EventCount in AIGInfo. The EventCount value of AIGInfo in the current AUX_SYNC_CTR PDU is less than Deadline, indicating that the AIG slave device is allowed to transmit the AIS access request via the AUX_SYNC_CTR_RSP PDU. After the AIG slave device receives the AIS random access command, in order to avoid conflict with the AIS access requests transmitted by other AIG slave devices, it will randomly delay for a certain time to receive the AIS random access command again and transmit the AIS access request, and the time of random delay will not exceed the Deadline. When Deadline is 0, it means that the deadline is infinite.

In one embodiment, when the master device obtains the link access request from the candidate slave device based on the synchronization control response packet. The synchronization control response packet carries request information. The request information comprises: a first request parameter for indicating a device address of the candidate slave device; a second request parameter for indicating a direction of audio data transmission corresponding to the candidate slave device; and a third request parameter for indicating a channel type corresponding to the candidate slave device. The CtrData of the AIS access request may be set as shown in FIG. 9(b), containing a 6-byte Device Address, a 1-bit Direction, a 10 bits PDU Size, and a 13 bits Audio ChM. The Device Address can be understood as the first request parameter for indicating a device address of the slave device (i.e., the candidate slave device) requesting access.

The Direction can be understood as the second request parameter, for indicating the direction of the audio data transmission corresponding to the candidate slave device. When the Direction field is set to 0, it indicates that the audio output direction. When the Direction field is set to 1, it indicates the audio input direction. PDU Size is a payload size of the AISD PDU requesting access.

Audio ChM can be understood as the third request parameter for indicating an audio channel mapping table (Channel Map, ChM) that can be supported by the slave device requesting access, wherein each bit represents a particular channel, and setting a certain bit to 1 represents that the slave device requesting access can support corresponding channel. In one embodiment, when the master device transmits the link access permit command based on the synchronization control data packet, the synchronization control data packet carries control information. The control information comprises at least one of the following: a first control parameter for indicating the number of the communication link which is allowed to access; a second control parameter for indicating a direction of audio data transmission corresponding to the communication link which is allowed to access; a third control parameter for indicating a channel type corresponding to the communication link which is allowed to access; a fourth control parameter for indicating an effective time of the link access permit command; a fifth control parameter for indicating a device address of the candidate slave device that is allowed to access; and a sixth control parameter for indicating a maximum number of bytes of a payload of the protocol data unit corresponding to the candidate slave device that is allowed to access.

As described earlier, the AIG slave device transmits its device address to the AIG master device via the AIS access request. The AIG master device receives the device addresses of a plurality of slave devices during the random access window and saves them in a device address list. After the random access window closes, the master device selects a specific slave device from the device address list and allows the specific slave device to access and establish the AIS link by transmitting the AIS access permit command to the slave device with corresponding device address. In one embodiment, the CtrData of the AIS access permit command may be set as shown in FIG. 9(c), including the link number AIS_SN (i.e., the aforementioned first control parameter), the access address (i.e., the aforementioned fifth control parameter), and CRCInit configured for the slave device permitted to access, and Direction (i.e., the aforementioned second control parameter), Audio Channel (i.e., the aforementioned third control parameter), PDU Size (i.e., the aforementioned sixth control parameter), and Effective Time (i.e., the aforementioned fourth control parameter) permitted to access.

Based on the AIS access permit command, the slave device uses the configured AIS_SN, Access Address, and CRCInit to receive the AISD PDUs transmitted by the AIG master device or to transmit the AISD PDUs to the AIG master device according to the Direction on the corresponding AIS link, or to reply with the acknowledgement according to the ACK MT. For example, the CtrData of the AIS terminate command can be set as shown in FIG. 9(d), containing 4 bits AIS_SN, 2 bits Reason, 6 bytes Device Address, and 18 bits Instant.

AIS_SN is the sequence number of the terminated AIS link. The Device Address is the device address of the slave device of the terminated AIS link. The Reason is the reason for terminating the AIS link. The Instant is the time for the AIS terminate command to take effect, which is the same as definition of EventCount in AIGInfo. The AIS terminate command takes effect when EventCount equals the Instant. Generally, the AIG master device transmits the AIS terminate command to the slave device with a specific device address to disconnect the AIS link with the specified AIS_SN. The AIG master device can also transmit the AIS terminate command with the AIS_SN configured to be 0xFF, and then all the AIS links are disconnected.

The AIG slave device can also transmit the AIS terminate command to the AIG master device to request to disconnect its own AIS link. The AIG slave device transmits the AIS terminate command in the random access window, and the AIG master device receives the AIS terminate command from the AIG slave device and transmits the AIS terminate command via the AUX_SYNC_CTR PDU to confirm disconnection of the corresponding AIS link. The Reason that can be set to disconnect the AIS link comprises three kinds. 0x01 indicates that a new device needs to be connected and one inactive device needs to be disconnected, 0x02 indicates that the AIS link is disconnected due to abnormal reasons such as insufficient power, and 0x03 indicates that the shutdown is used to disconnect all the AIS links.

It should be noted that for the AMIMO wireless audio system shown in FIG. 2, the AIG link protocol can flexibly configure the number of audio input links and audio output links under constraint of the total number of links. For example, when applied to the AMIMO wireless audio system consisting of a mixture of wireless multi-microphones and wireless multi-channel playback devices, any number of wireless multi-microphones and any number of wireless multi-channel playback devices can be configured. Moreover, the AIG link protocol supports sharing of wireless time slot resources among all the AIS links (i.e., each time slot for audio data transmission can be used for receiving the audio data packet and transmitting audio data packets), which overcomes the defect that the BIG and CIG protocols of BLE Audio fixedly allocate wireless time slot resources to each link, and improves ability of multiple audio input links and multiple audio output links to adapt to changes in wireless channels. In addition, for the wireless multi-microphone application scenario, the AMIMO master device transmits the block resource allocation information to multiple wireless microphones through the AISM PDU, which can be regarded as the behavior of replying with the acknowledgement in a batch, thereby overcoming the defect that the CIG protocol replies acknowledgement to each wireless microphone respectively and wastes time slot resources, and improving the link efficiency.

Finally, the AIG link protocol can also improve the problem of access difficulties of multiple input links and multiple output links, and improve the access efficiency of communication links to a certain extent. It should be noted that the multiple optional implementations of the multiple embodiments described in the present invention may be realized in combination with each other or separately without conflicting with each other, which is not limited by the present invention.

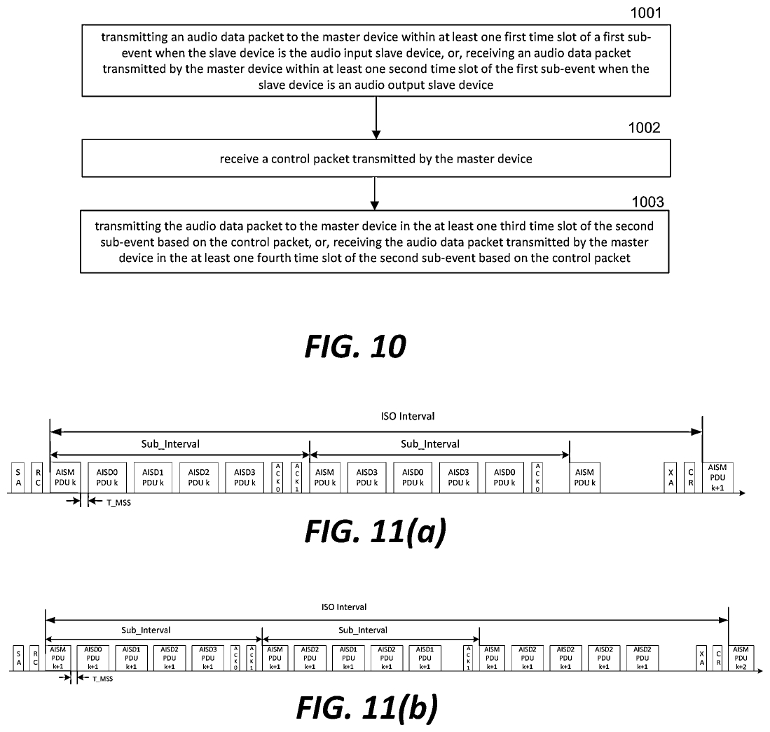

As shown in FIG. 10, the slave device wirelessly communicates with the master device in successive isochronous intervals based on a communication link in one embodiment. The slave device can be one audio input slave device or one audio output slave device. A plurality of sub-events are comprised within one isochronous interval, a plurality of time slots for audio data transmission are comprised within one the sub-event, and each of the time slots for audio data transmission is available to be used by the master device to receive the audio data packet and to transmit the audio data packet.

A wireless audio data transmission method applied to a slave device comprises the following operations. At 1001, the slave device transmits an audio data packet to the master device within at least one first time slot of a first sub-event when the slave device is the audio input slave device, or, receives an audio data packet transmitted by the master device within at least one second time slot of the first sub-event when the slave device is an audio output slave device.

At 1002, the slave device receives a control packet transmitted by the master device. The control packet is configured to indicate at least one third time slot within a second sub-event in which the slave device is permitted to transmit the audio data packet to the master device through corresponding communication link, or, at least one fourth time slot in which the slave device is permitted to receive the audio data packet transmitted by the master device through corresponding communication link.

At 1003, the slave device transmits the audio data packet to the master device in the at least one third time slot of the second sub-event based on the control packet, or, receives the audio data packet transmitted by the master device in the at least one fourth time slot of the second sub-event based on the control packet. The first sub-event and the second sub-event are different sub-events within the consecutive isochronous intervals and the second sub-event is later than the first sub-event. The first time slot, the second time slot, the third time slot, and the fourth time slot are the time slots used for the audio data transmission. A time slot distribution of the at least one first time slot in the first sub-event is different from a time slot distribution of the at least one third time slot in the second sub-event. A time slot distribution of the at least one second time slot in the first sub-event is different from a time slot distribution of the at least one fourth time slot in the second sub-event.

In one embodiment, the isochronous interval further comprises a bidirectional advertising communication time slot, the wireless audio data transmission method further comprises: when the slave device is a candidate slave device requesting access to the master device, the slave device receives a synchronization control data packet transmitted by the master device based on a periodic advertising channel in the bidirectional advertising communication time slot and transmits a synchronization control response packet based on the synchronization control data packet to the master device on the periodic advertising channel.

The slave device obtains a link random access command transmitted by the master device based on the synchronization control data packet, transmits a link access request to the master device via the synchronization control response packet. The link access request carries an indication that the slave device is the audio input slave device or the audio output slave device.

The slave device further obtains a link access permit command transmitted by the master device based on the synchronization control data packet and establishes the communication link with the master device based on the link access permit command. It should be noted that the embodiment corresponding to FIG. 10 is one embodiment of the wireless audio data transmission method applied to the slave device, the wireless audio data transmission method applied to the slave device corresponds to the wireless audio data transmission method applied to the master device. Accordingly, it is possible to refer to the related description in the above-described embodiment of the wireless audio transmission method applied to the master device, and the same beneficial effect can be achieved. In order to avoid repetition of the description, it will not be repeated herein.

To facilitate the description of the present invention, examples are illustrated as follows. Taking a wireless game console audio system as a specific example to illustrate in detail a working principle of the AMIMO wireless audio transmission method based on the AIG links, it is assumed that the wireless game console audio system comprises an AMIMO master device and four AMIMO slave devices.

The AMIMO master device is mainly a smartphone, but can also be a personal computer, a tablet PC, a smart TV, etc. The four AMIMO slave devices include two wireless audio input devices and two wireless audio output devices, which respectively correspond to a TWS microphone composed of two mono wireless microphones and a TWS earphone composed of two mono earphones, respectively.

The AMIMO master device is set to establish an AIS0 link with a left channel earphone (corresponding AIS_SN is equal to 0), an AIS1 link with a right channel earphone (corresponding AIS_SN is equal to 1), an AIS2 link with a left channel wireless microphone (corresponding AIS_SN is equal to 2), an AIS3 link with a right channel wireless microphone (corresponding AIS_SN is equal to 3). The AIS0, AIS1, AIS2 and AIS3 links form the AIG.

Let the AISM field of the header of the AISM PDU shown in FIG. 3 be 1, and the header of the AISM PDU be increased by 6 bytes, which comprises 3 bits Num_AIS, 4 bits ACK MT, 9 bits SE_SN, and 32 bits BRAT. Let the AISD field of the header of the AISD PDU shown in FIG. 4 be 1, and the header of the AISD PDU be increased by 1 byte, which comprises 1 bit Direction, 3 bits AIS SN, and 4 bits PDU SN.

The time slot structure of the wireless game console audio system is further set as follows. In the above wireless game console audio system, a sampling rate of digital audio signal of each channel is 48 KHz, and the number of quantization bits of each sampling point is 16. The digital audio signal of each channel is encoded by Low Complexity Communication Codec (LC3), a frame length is 10 ms, an encoding rate is 80 kbps, and each frame of audio data after encoding is 100 bytes. The wireless game console audio system based on the AIG protocol adopts a time slot structure shown in FIG. 11(a)/FIG. 11(b). The communication time is divided into 10 ms isochronous intervals, and a starting point of each isochronous interval is a starting point of transmitting the first AISM PDU. BLE 2 Mbps transmission rate is used, the AISM PDU without payload occupies an airtime of 68 us, the AISD Data PDU with 100 bytes of audio data occupies an airtime of 448 us, and the AISD NULL PDU only carrying acknowledgement and without payload occupies an airtime of 48 us. An interval between PDUs (T_MSS: Time of Minimum Slot Space) is 120 us, i.e., the interval between a last bit of the previous PDU and a first bit of the subsequent PDU is 120 us. In each isochronous interval, three sub-events are included for transmitting and receiving the AISM PDUs and the AISD PDUs between the AMIMO master device and the four AMIMO slave devices of the wireless game console audio system.

Each sub-event contains a time for the AMIMO master to broadcast the AISM PDU, a time for the AMIMO master to transmit and receive four AISD Data PDU to and from each of the four AMIMO slaves, and a time for the AMIMO slave to send 2 AISD Data PDU with the acknowledgement to the AMIMO master. Therefore, the interval Sub_Interval between two sub-events is equal to 2.796 ms; three sub-events occupy a total of 8.388 ms. In each isochronous interval, it also contains time of transmitting the extended advertising (ADV_EXT_IND) PDU on the primary advertising channel, transmitting the Auxiliary Advertising (AUX_ADV_IND) PDU on the Secondary Advertising channel, and transmitting the Synchronization Control (AUX_SYNC_CTR) PDU on the periodic advertising channel by the AMIMO master device. In order to save the time slot resources, these PDUs are sent in a time-sharing manner, i.e., they are sent in separate isochronous intervals, such as the time slots of XA shown in FIG. 11(a)/FIG. 11(b), wherein XA represents the three advertising PDUs mentioned above. In each isochronous interval, it may also contain the interval T_MSS between AUX_SYNC_CTR PDU transmitting by the AMIMO master device and the AUX_SYNC_CTR_RSP PDU transmitting by the AMIMO slave device, i.e. 120 us.

The time slot for the multiple AMIMO slave devices to transmit AUX_SYNC_CTR_RSP PDUs is shared. Therefore, they will be managed by time-division multiplexing, that is, try to avoid transmitting AUX_SYNC_CTR_RSP PDUs at the same time within the same isochronous intervals. The interval between the starting point of the XA and the starting point of the first AISM PDU of the adjacent isochronous interval is 1.25 ms. The parameters of the above time slot structure correspond to the AIGInfo carried by the AUX_SYNC_CTR PDU as shown in FIG. 7, wherein AIG_Offset=1.25 ms, ISO_Interval=10 ms, Nun_AIS=4, Num_RU=4, NSE=3, Sub_Interval=2.796 ms, Max_PDU1=0, Max_PDU2=100 bytes, all bits of ChM are set to 1, PHY is configured to 1 (corresponding to BLE 2M PHY), and EventCount starts counting from 0.

As shown in FIG. 11(a), in one isochronous interval numbered k, the AMIMO master device first transmits the AISM PDU numbered k at the first SE, i.e., AISM PDU k, wherein the payload length (Length) is 0, the AISM field of the extended header is assigned to 1, Num_AIS is equal to 4 to indicate that 4 AIS links are accessed, and SE_SN is equal to 0 to indicate that the sequence number of SE is 0. The BRAT field contains four resource allocation units, and the enable signals EN_0, EN_1, EN_2, and EN_3 numbered from 0 to 3 are assigned to 1.

The link numbers AIS SN corresponding to the resource allocation units numbered 0 to 3 are 0, 1, 2, and 3, respectively. The number PDU SN of the AISD PDUs all are k (the PDU SN can also be k−1, k−2, k−3, etc., which represent the transmitting of AISD PDUs numbered k−1, k−2, and k−3 at the isochronous intervals). The Direction fields of the resource allocation units numbered 0 to 3 are 0, 0, 1, and 1, respectively, which represent that the AIS links with AIS SNs of 0 and 1 are the audio output direction, and the AIS links with AIS SNs of 2 and 3 are the audio input direction. Bit 0 and bit 1 of the ACK MT are set to 1, and the other bits of the ACK MT are set to 0, which represents that the AIS links with AIS SNs of 0 and 1 in the audio output direction need to reply with an acknowledgement. After transmitting the AISM PDU k within the first SE, the AMIMO master device first transmits the AISD0 PDU k to the left-channel earphone connected to the AIS link with AIS SN of 0, and then transmits the AISD1 PDU k to the right-channel earphone connected to the AIS link with an AIS SN of 1, according to the resource allocation information of the BRAT. Then, the AMIMO master device receives AISD2 PDU k transmitted by the left-channel wireless microphone connected to the AIS link with AIS SN of 2, and then receives AISD3 PDU k transmitted by the right-channel wireless microphone connected to the AIS link with AIS SN of 3. Finally, the AMIMO master device receives AISD Null PDU carrying the acknowledgement (ACK0) transmitted by the left-channel earphone, and then receives AISD Null PDU carrying the acknowledgement (ACK1) transmitted by the right-channel earphone, wherein NPI of ACK0 is set to 1, Length is set to 0, the Direction filed is set to 0, AIS SN is set to 0, and PDU SN is set to k; NPI of ACK1 is set to 1, Length is set to 0, the Direction field is set to 0, AIS SN is set to 1, and PDU SN is set to k.

If the AISD0 PDU k transmitted by the AMIMO master device within the first SE is not correctly received by the left-channel earphone, the AISD1 PDU k transmitted by the AMIMO master device is correctly received by the right-channel earphone and the ACK1 is also correctly received by the AMIMO master device, the AISD2 PDU k transmitted by the left-channel wireless microphone is correctly received by the AMIMO master device, but the AISD3 PDU k transmitted by the right channel wireless microphone is not correctly received by the AMIMO master device, then the AMIMO master device can transmit the AISM PDU numbered k again within the second SE, i.e., the AISM PDU k. SE_SN is equal to 1, and the enable signals EN_0, EN_1, EN_2 and EN_3 numbered 0 to 3 in BRAT are all assigned to 1; the link numbers AIS SN corresponding to the resource allocation units numbered 0 to 3 are 3, 0, 3, 0 (different links are arranged alternately, or they can be arranged as 0, 3, 0, 3), and the number PDU SN of the PDUs all are k. The Direction fields of the resource allocation units numbered 0 to 3 are 1, 0, 1, 0. The bit 0 of the ACK MT is set to 1, the other bits of the ACK MT are 0, it represents that only the AIS link with AIS SN of 0 in the audio output direction needs to reply with the acknowledgement. That is, AISD0 PDU k and AISD3 PDU k are sent twice in the second SE.

After transmitting the AISM PDU k within the second SE, the AMIMO master device, according to the resource allocation information of the BRAT, first receives the AISD3 PDU k transmitted by the right-channel wireless microphone connected to the AIS link with AIS SN of 3, and then transmits the AISD0 PDU k to the left-channel earphone connected to the AIS link with AIS SN of 0. Then, if the AMIMO master device does not correctly receive the AISD3 PDU k, the AMIMO master device can receive the AISD3 PDU k transmitted by the right channel wireless microphone connected by the AIS link with AIS SN of 3 again and transmit again the AISD0 PDU k to the left-channel earphone connected by the AIS link with AIS SN of 0. Finally, the AMIMO master device receive the AISD Null PDU carrying the acknowledgement (ACK0) transmitted by the left-channel earphone, wherein the NPI of ACK0 is set to 1, Length is set to 0, the Direction field is set to 0, AIS SN is set to 0, and PDU SN is set to k.

If the AISD0 PDU k transmitted by the AMIMO master device in the second SE is correctly received by the left-channel earphone and the ACK0 is also correctly received by the AMIMO master device, and the AISD3 PDU k transmitted by the right channel wireless microphone is also correctly received by the AMIMO master device, at this time, the AMIMO master device can transmit the AISM PDU numbered k again in the third SE, wherein SE_SN is equal to 2, and the enable signals EN_0, EN_1, EN_2 and EN_3 numbered from 0 to 3 in the BRAT are all assigned to 0. The AMIMO slave device receives the AISM PDU in the third SE and ends transmitting and receiving the AISD PDUs numbered k within the current isochronous interval. It can be seen that, in the two SEs, the AIS links numbered 1 and 2 are respectively used one transmitting opportunity, while the AIS links numbered 0 and 3 are given three transmitting opportunities, respectively, which realizes the agile allocation of time slot resources among different AIS links, improves the overall link efficiency, and improves the transmission reliability of the AIS links numbered 0 and 3.

As shown in FIG. 11(b), in the isochronous interval numbered k+1, the AMIMO master device first transmits the AISM PDU numbered k+1 at the first SE, i.e., AISM PDU k+1, wherein the payload length (Length) is 0, the AISM field of the extended header is assigned to 1, Num_AIS is equal to 4, it represents that 4 AIS links are accessed, SE_SN is equal to 0. The BRAT field contains four resource allocation units, and the enable signals EN_0, EN_1, EN_2, and EN_3 numbered 0 to 3 are all assigned to 1.

The link numbers AIS SN corresponding to the resource allocation units numbered 0 to 3 are 0, 1, 2, and 3, respectively, and the numbers PDU SNs of the PDUs all are k+1. The Direction field of the resource allocation units numbered 0 to 3 are 0, 0, 1, and 1, respectively, it indicates that the AIS links with AIS SN of 0 and 1 are the audio output direction, and the AIS links with AIS SN of 2 and 3 are the audio input direction. Bit 0 and bit 1 of the ACK MT are set to 1, and the other bits of the ACK MT are 0, it represents that the AIS links with AIS SN of 0 and 1 in the audio output direction are requested to reply with the acknowledgement. The AMIMO master device transmits the AISM PDU k+1 within the first SE, and then according to the resource allocation information of the BRAT, the AMIMO master device transmits the AISD0 PDU k+1 first to the left-channel earphone connected to the AIS link with AIS SN of 0, and then transmits AISD1 PDU k+1 to the right-channel earphone connected to the AIS link with AIS SN of 1. Then, the AMIMO master device receives AISD2 PDU k+1 transmitted by the left channel wireless microphone connected to the AIS link with AIS SN of 2, and receives AISD3 PDU k+1 transmitted by the right channel wireless microphone connected to the AIS link with AIS SN 3. Finally, the AMIMO master device receives the AISD Null PDU carrying the acknowledgement (ACK0) transmitted by the left-channel earphone and the AISD Null PDU carrying the acknowledgement (ACK1) transmitted by the right-channel earphone, wherein the NPI of ACK0 is set to 1, Length is set to 0, Direction field is set to 0, and the AIS SN is set to 0, the PDU SN is set to k+1, the NPI of ACK1 is set to 1, Length is set to 0, Direction field is set to 0, AIS SN is set to 1, and PDU SN is set to k+1.

If the AISD1 PDU k+1 transmitted by the AMIMO master device within the first SE is not correctly received by the right-channel earphone, the AISD0 PDU k+1 transmitted by the AMIMO master device is correctly received by the left-channel earphone and the ACK0 is also correctly received by the AMIMO master device, the AISD3 PDU k+1 transmitted by the right channel wireless microphone is correctly received by the AMIMO master device, but the AISD2 PDU k+1 transmitted by the left channel wireless microphone is not correctly received by the AMIMO master device; then the AMIMO master device can transmit the AISM PDUs numbered k+1 again within the second SE, i.e., the AISM PDU k+1, wherein the SE_SN is equal to 1, and the enable signals EN_0, EN_1, EN_2, and EN_3 numbered 0 to 3 in the BRAT are all assigned to 1. The link number AIS SN corresponding to the resource allocation units numbered 0 to 3 is 2, 1, 2, 1, respectively. The number PDU SN of the PDUs are all k+1, and the Direction field of the resource allocation units numbered 0 to 3 is 1, 0, 1, 0, respectively. Bit 1 of the ACK MT is set to 1, and the other bits of the ACK MT are 0, which represent that the AIS link with AIS SN of 1 in the audio output direction need to reply with the acknowledgement. That is, AISD1 PDU k+1 and AISD2 PDU k+1 are sent twice within the second SE. After transmitting AISM PDU k+1 within the second SE, according to the resource allocation information of the BRAT, the AMIMO master device firstly receives the AISD2 PDU k+1 transmitted by the left-channel wireless microphone connected to the AIS link with AIS SN of 2, and then transmits AISD1 PDU k+1 to the right-channel earphone connected to the AIS link with AIS SN of 1. Then, if AISD2 PDU k+1 is not received correctly, the AMIMO master device can receive AISD2 PDU k+1 transmitted by the left-channel wireless microphone connected to the AIS link with AIS SN of 2 again, and transmit AISD1 PDU k+1 again to the right-channel earphone connected to the AIS link with AIS SN of 1. Finally, the AMIMO master device receive the AISD Null PDU carrying the acknowledgement (ACK1) transmitted by the right-channel earphone, wherein the NPI of ACK1 is set to 1, Length is set to 0, Direction field is set to 0, AIS SN is set to 0, and the PDU SN is set to k+1.

If the AISD1 PDU k+1 transmitted by the AMIMO master device within the second SE is correctly received by the right-channel earphone and the ACK1 is also correctly received by the AMIMO master device, but the AISD2 PDU k+1 transmitted by the left channel wireless microphone is not correctly received by the AMIMO master device; then, the AMIMO master device can transmit again AISM PDU numbered k+1 within the third SE, wherein SE_SN is equal to 2, the enable signals EN_0, EN_1, EN_2 and EN_3 numbered 0 to 3 in the BRAT are assigned to 1, 0, 1, 0, respectively, and the link number AIS SN corresponding to the resource allocation units numbered 0 and 3 are both 2, and the number PDU SN of the PDUs all are k+1. The Direction fields of the resource allocation units numbered 0 and 3 are both 1, and all bits of the ACK MT are 0. That is, the AISD2 PDU k+1 is sent twice in the third SE. After transmitting the AISM PDU k+1 in the third SE of the AMIMO master device, the AMIMO master device only receives AISD2 PDU k+1 transmitted by the left-channel wireless microphone connected to the AIS link with AIS SN of 2. If AISD2 PDU k+1 is not received correctly at the first time, the AMIMO master device can receive it again. The AMIMO master device can receive the AISD2 PDU k+1 twice in the third SE. It can be seen that, within the three SEs, the AIS links numbered 0 and 3 use one transmission opportunity, respectively, whereas the AIS link numbered 1 obtains three transmission opportunities, and the AIS link numbered 2 obtains five transmission opportunities. Moreover, it is also possible to allocate all the four timeslot resources within the third SE to the AIS link numbered 2, so that the AIS link numbered 2 can obtain up to seven transmission opportunities.

Based on the example in FIG. 11(a) and the example in FIG. 11(b), it can be seen that by performing agile allocation of timeslot resources among different AIS links, the link with poor communication performance can naturally obtain more timeslot resources or transmitting opportunities, so as to improve the transmission reliability of the link. It is to be noted that, for the example in FIG. 11(a) and the example in FIG. 11(b), any one of the AISD1 PDU k+1, the AISD2 PDU k+1, the AISD3 PDU k+1, and the AISD4 PDU k+1 that is not successfully transmitted within the isochronous interval numbered k+1 can also be transmitted repeatedly within the isochronous intervals numbered k+2, K+3, . . . , until a Flush Time (FT) timeout. The PDU SN remains unchanged. FT=1 indicates that it is sent only in the current isochronous interval, and will not be retransmitted again in the next isochronous time interval. FT=2 indicates that it can be retransmitted in two consecutive isochronous intervals. The larger the FT is, the transmission reliability is higher, but the higher the transmission delay is. In order to make the transmission delay as low as possible during practical application, FT=1 can be set.

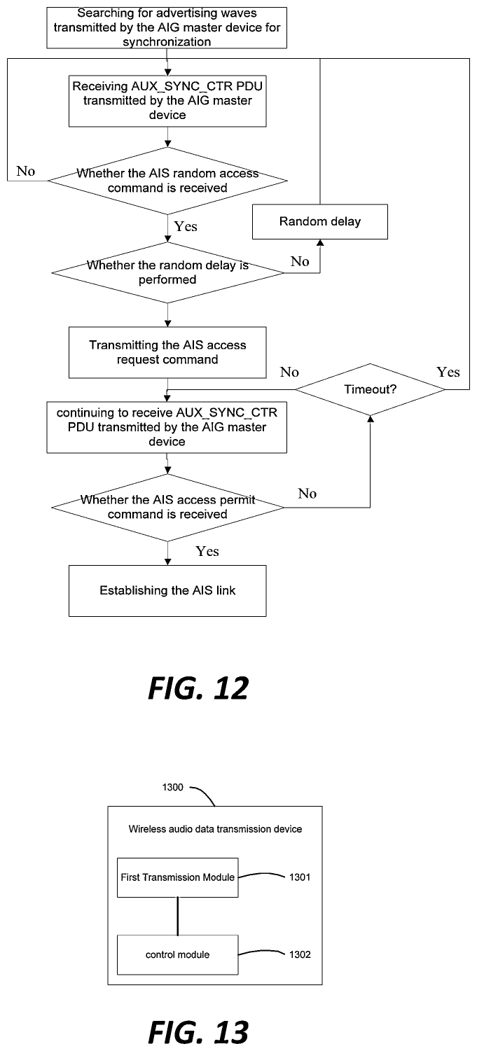

The flow of the AMIMO slave device accessing the AIG to establish the AIS link can be shown in FIG. 12. The slave device to be accessed first searches for ADV_EXT_IND PDU on the primary advertising channel, and then searches for AUX_ADV_IND PDU on the secondary advertising channel according to indication information of ADV_EXT_IND PDU. Then, the slave device to be accessed receives the AUX_SYNC_CTR PDU on the periodic advertising channel according to information provided by the AUX_ADV_IND PDU, so as to obtain the synchronization information of the AIG link. After the AMIMO slave device completes synchronization with the AMIMO master based on the synchronization information, if it receives the AIS random access command transmitted by the AMIMO master device through the AUX_SYNC_CTR PDU, it receives the AIS random access command again after randomly delaying a certain number of isochronous interval and transmits the AIS access request through the AUX_SYNC_CTR_RSP PDU. In order to ensure the reliability, it can transmit the AIS access request several times. After the slave device transmits the AIS access request, it continues to receive the AUX_SYNC_CTR PDU transmitted by the master device and determines whether it is carrying the AIS access permit command. If the AIS access permit command is received and the AIS link information assigned by the AMIMO master device for this slave device is obtained, including AIS_SN, Access Address and CRCInit, as well as the Direction, Audio channel, PDU Size and effective time, so that after the AIS access permit command takes effect, it accesses the AIG link, and transmits and receives AISD PDUs according to the AISM PDUs. If it does not receive the AIS access permit command and the timeout occurs, it will continue to receive AUX_SYNC_CTR PDU transmitted by the AMIMO master device and determine whether it is the AIS random access command to start a new round of access process. If there is no timeout, then it continue to receive AUX_SYNC_CTR PDU transmitted by the AMIMO master device and determine whether it is the AIS access permit command.

For the related art, when accessing a new CIS slave device, the CIS master device needs to open a search window to search for the slave device. When the more CIS links the CIS master device establishes, the fewer time slots are used to search for the new slave device, and the more difficult it is to establish a new CIS link or to access a new slave device. The CIS master device has to keep enough search time slots in order to ensure that the new slave device can be accessed quickly, which will reduce the efficiency of the link. In the present invention, by adopting the AIG protocol, it is possible to make the access process of the slave device require fewer time slots and the access efficiency is higher.

In one embodiment, a plurality of wireless audio input devices in the MIMO wireless audio system shown in FIG. 2 can be removed, so that the MIMO wireless audio system can be reduced to a multi-output wireless audio system, i.e., the N slave devices only comprise the audio output slave devices. It is clear that the wireless audio data transmission method described in the present invention and applied to the master device as shown in FIG. 1 and the wireless audio data transmission method described in the present invention and applied to the slave devices as shown in FIG. 10 can also be applied to the multi-output wireless audio system with a simple modification. Specifically, all contents related to the audio input slave device in the wireless audio data transmission method need to be deleted.

That is, the master device does not allocate the AIS link or the timeslot resources to the audio input slave device via BRAT in AISM PDUs. By setting the BRAT in the AISM PDU sent by the master device, it is possible that the timeslot resources within each sub-event are allocated only to the audio output slave device and not to the audio input slave device. In this case, Direction in each resource allocation unit in the BRAT in the AISM PDU indicates the audio output direction, or alternatively, the bit (Direction) indicating the data transmission direction is no longer set in each resource allocation unit in the BRAT in the AISM PDU, and the direction of data transmission defaults to be the audio output direction.

In one embodiment, a plurality of wireless audio output devices in the MIMO wireless audio system shown in FIG. 2 can be removed, so that the MIMO wireless audio system can be reduced to a multi-input wireless audio system. I.e., the N slave devices only comprise the audio input slave devices. It is clear that the wireless audio data transmission method applied to the master device as shown in FIG. 1 and described in the present invention and the wireless audio data transmission method applied to the slave devices as shown in FIG. 10 and described in the present invention s can also be applied to the multi-input wireless audio system with a simple modification. Specifically, all contents related to the audio output slave device in the wireless audio data transmission method above mentioned need to be deleted.

That is, the master device does not allocate the AIS link or the time slot resources to the audio output slave device by configuring the BRAT in the AISM PDU. By configuring the BRAT in the AISM PDU sent by the master device, it is possible that the timeslot resources within each sub-event are allocated only to the audio input slave device and not to the audio output slave device. In this case, Direction in each resource allocation unit in the BRAT in the AISM PDU indicates the audio input direction or, alternatively, the bit indicating the data transmission direction is no longer set in each resource allocation unit in the BRAT, and the direction of data transmission defaults to be the audio input direction.

In the present invention, the master device may first transmit a control packet (such as AISM PDU) to the slave devices in each sub-event to flexibly allocate the time slots in the sub-event to the slave devices connected to the corresponding AIS link depend on requirement according to the block resource allocation table in the control packet. The master device transmits the audio data packets or receives the audio data packets on the respective time slots according to the block resource allocation table. The slave device transmits the audio data packet or receives the audio data packet on corresponding time slots according to the block resource allocation table.

The master device configures the block resource allocation table in the control packet according to requirements. Specifically, the master device configures the block resource allocation table in the control packet in the current sub-event according to success or failure condition that the audio data packet sent by the slave device before the current sub-event is received by the master device and/or success or failure condition that the audio data packet sent by the master device before the current sub-event is received by the slave device.

FIG. 13 shows a wireless audio data transmission device 1300 according to one embodiment of the present invention. The wireless audio data transmission device 1300 can be used as a master device. The master device communicates wirelessly with N slave devices in consecutive isochronous intervals based on N communication links, respectively. The N slave devices comprise one or more audio input slave devices and one or more audio output slave devices. N is an integer greater than or equal to two.

A plurality of sub-events are comprised within one isochronous interval, a plurality of time slots for audio data transmission are comprised within one sub-event. Each of the time slots for audio data transmission is available to be used for both receiving an audio data packet and transmitting an audio data packet.

The device 1300 comprises: a first transmission module 1301 configured for receiving the audio data packet transmitted by a first target device within at least one first time slot of a first sub-event, and/or, transmitting the audio data packet to a second target device within at least one second time slot of the first sub-event, wherein the first target device is one audio input slave device of the N slave devices and the second target device is one audio output slave device of the N slave devices; a control module 1302 configured for transmitting a control packet to the N slave devices in an event of a failure to receive the audio data packet transmitted by the first target device in the first sub-event, and/or, in an event of a failure to transmit the audio data packet to the second target device, the control packet being configured to indicate at least one third time slot within a second sub-event in which the first target device is permitted to transmit the audio data packet to the master device through corresponding communication link, and/or at least one fourth time slot in the second sub-event in which the second target device is permitted to receive the audio data packet transmitted by the master device through corresponding communication link.

The first sub-event and the second sub-event are different sub-events within the consecutive isochronous intervals and the second sub-event is later than the first sub-event. The first time slot, the second time slot, the third time slot, and the fourth time slot are the time slots used for the audio data transmission, a time slot distribution of the at least one first time slot in the first sub-event is different from a time slot distribution of the at least one third time slot in the second sub-event, and/or, a time slot distribution of the at least one second time slot in the first sub-event is different from a time slot distribution of the at least one fourth time slot in the second sub-event.

The wireless audio data transmission device 1300 provided according to one embodiment of the present invention is capable of realizing various processes in one embodiment of the wireless audio data transmission method applied to the master device, which are not repeated herein to avoid repetition.

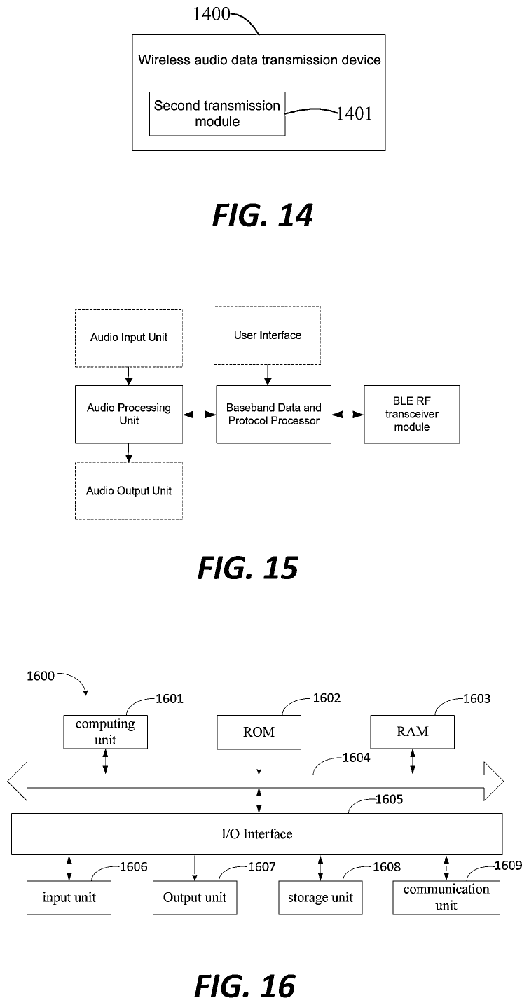

FIG. 14 shows a wireless audio data transmission device 1400 according to one embodiment of the present invention. The wireless audio data transmission device 1400 is used as one slave device. The slave device wirelessly communicates with the master device in consecutive isochronous intervals based on a communication link. The slave device is one audio input slave device or one audio output slave device.

A plurality of sub-events are included within one isochronous interval, a plurality of time slots for audio data transmission are comprised within one sub-event. Each of the time slots for audio data transmission is available to be used for both receiving an audio data packet and transmitting an audio data packet. The wireless audio data transmission device 1400 includes: a second transmission module 1401. The second transmission module 1401 is configured for transmitting the audio data packet to the master device within at least one first time slot of a first sub-event when the slave device is the audio input slave device, or, receiving the audio data packet transmitted by the master device within at least one second time slot of the first sub-event when the slave device is the audio output slave device. The second transmission module 1401 is further configured for receiving a control packet transmitted by the master device, in the event of a failure to transmit the audio packet to the master device within the first sub-event, or, in the event of a failure to receive the audio packet transmitted by the master device within the first sub-event. The control packet is configured to indicate at least one third time slot within a second sub-event in which the slave device is permitted to transmit the audio data packet to the master device through corresponding communication link, or, at least one fourth time slot in which the slave device is permitted to receive the audio data packet transmitted by the master device through corresponding communication link. The second transmission module 1401 is further configured for transmitting the audio data packet to the master device in the at least one third time slot of the second sub-event based on the control packet, or, receiving the audio data packet transmitted by the master device in the at least one fourth time slot of the second sub-event based on the control packet.

The first sub-event and the second sub-event are different sub-events within the consecutive isochronous intervals and the second sub-event is later than the first sub-event. The first time slot, the second time slot, the third time slot, and the fourth time slot are the time slots used for the audio data transmission, a time slot distribution of the at least one first time slot in the first sub-event is different from a time slot distribution of the at least one third time slot in the second sub-event, and/or, a time slot distribution of the at least one second time slot in the first sub-event is different from a time slot distribution of the at least one fourth time slot in the second sub-event.

The wireless audio data transmission device 1400 according to one embodiment of the present invention is capable of realizing various processes in one embodiment of the wireless audio data transmission method applied to the slave device, which will not be repeated herein to avoid repetition.

A wireless audio data transmission system is provided according to one embodiment of the present invention. The system comprises: N slave devices and a master device. The master device communicates wirelessly with the N slave devices in consecutive isochronous intervals based on N communication links, respectively. The N slave devices comprise one or more audio input slave devices and one or more audio output slave devices, and N is an integer number greater than or equal to 2. A plurality of sub-events is comprised in one isochronous interval, and one sub-event comprises a plurality of time slots for audio data transmission. Each of the time slots for audio data transmission being usable for both receiving the audio data packet and transmitting the audio data packets. The master device is configured for receiving an audio data packet transmitted by a first target device within at least one first time slot of a first sub-event, and/or, transmitting an audio data packet to a second target device within at least one second time slot of the first sub-event, wherein the first target device is one audio input slave device of the N slave devices and the second target device is one audio output slave device of the N slave devices. The master device is further configured for transmitting a control packet to the N slave devices in an event of a failure to receive the audio data packet transmitted by the first target device in the first sub-event, and/or, in an event of a failure to transmit the audio data packet to the second target device. The control packet is configured to indicate at least one third time slot within a second sub-event in which the first target device is permitted to transmit the audio data packet to the master device through corresponding communication link, and/or at least one fourth time slot in the second sub-event in which the second target device is permitted to receive the audio data packet transmitted by the master device through corresponding communication link.

The first sub-event and the second sub-event are different sub-events within the consecutive isochronous intervals and the second sub-event is later than the first sub-event. The first time slot, the second time slot, the third time slot, and the fourth time slot are the time slots used for the audio data transmission, a time slot distribution of the at least one first time slot in the first sub-event is different from a time slot distribution of the at least one third time slot in the second sub-event, and/or, a time slot distribution of the at least one second time slot in the first sub-event is different from a time slot distribution of the at least one fourth time slot in the second sub-event.

The wireless audio data transmission system provided according to one embodiment of the present invention is capable of realizing various processes in one embodiment of the wireless audio data transmission method applied to the master device and the slave device side, which are not repeated herein to avoid repetition.

When a device shown in FIG. 15 is an AMIMO wireless audio input device (e.g., a wireless microphone). The AMIMO wireless audio input device may comprise a user interface, an audio input unit, an audio processing unit, a baseband data and protocol processor, and a BLE RF transceiver module.

The audio input unit acquires a digital audio signal and transmits it to the audio processing unit. The audio processing unit encodes the digital audio signal into audio data using LC3 compression coding. The baseband data and protocol processor executes the BLE Audio-related BLE protocol and the aforementioned AIG protocol and processes the audio data into AISD PDUs suitable for being transmitted by the BLE radio frequency transceiver module. The BLE RF (Radio Frequency) transceiver module is used for transmitting and receiving BLE wireless signals or PDUs, including transmitting AISD PDUs and receiving AISM PDUs, receiving AUX_SYNC_CTR PDUs and transmitting AUX_SYNC_CTR_RSP PDUs. The BLE RF transceiver module can also support BLE high speed rate physical layer technology, such as 4 Mbps, 6 Mbps, 8 Mbps, etc. The user interface can be keypad, touchpad, wireless control interface and so on.

When the device shown FIG. 15 is an AMIMO wireless audio output device (wireless mono earphone), it can also comprise a user interface, an audio output unit, an audio processing unit, a baseband data and protocol processor, and a BLE RF transceiver module.

At this time, the baseband data and protocol processor executes the BLE Audio-related BLE protocol and the AIG protocol, processes the AISD PDU received by the BLE RF transceiver module, and transmits it to the audio processing unit. The audio processing unit is used for post-processing such as LC3 audio decoding, packet loss processing, equalization, and sound effects. The audio output unit is configured to convert audio signals into sound signals. The BLE RF transceiver module is used for transmitting and receiving BLE wireless signals or various PDUs, including receiving AISM PDUs and AISD PDUs, transmitting AISD NULL PDUs, receiving AUX_SYNC_CTR PDUs and transmitting AUX_SYNC_CTR_RSP PDUs.

The BLE RF transceiver module can also support BLE high rate physical layer technology, e.g., 4 Mbps, 6 Mbps, 8 Mbps, etc.; the user interface can be a keypad, touchpad, wireless control interface, etc. When the device shown in FIG. 15 is the AMIMO master device, it may also comprise a user interface, an audio input unit, an audio output unit, an audio processing unit, a baseband data and protocol processor, and a BLE RF transceiver module. At this time, the audio input unit acquires a digital audio signal and transmits it to the audio processing unit, which compresses and encodes the digital audio signal into audio data using LC3.

The baseband data and protocol processor executes the BLE Audio-related BLE protocol and the AIG protocol, and processes the audio data into AISD PDUs suitable for transmission by the BLE RF transceiver module. The baseband data and protocol processor also executes the BLE Audio-related BLE protocol and the AIG protocol, processes the AISD PDUs received by the BLE RF transceiver module, and transmits them to the audio processing unit.

The audio processing unit is used for post-processing such as LC3 audio decoding, packet loss processing, equalization and sound effects. The audio output unit is configured to convert audio signals into sound signals. The BLE RF transceiver module is used for transmitting and receiving BLE wireless signal or PDU, including transmitting AISM PDUs, AISD PDUs, and AUX_SYNC_CTR PDUs, and receiving AISD PDUs and AUX_SYNC_CTR_RSP PDUs.

The BLE RF transceiver module can also support BLE high rate physical layer technology, e.g., 4 Mbps, 6 Mbps, 8 Mbps, etc. The user interface may be a keypad, a touchpad, a wireless control interface, and the like. According to one embodiment of the present invention, the present invention also provides an electronic device, a readable storage medium.

FIG. 16 illustrates a schematic block diagram of an electronic device 1600 that may be used to implement embodiments of the present invention. As shown in FIG. 16, the device 1600 comprises a computing unit 1601 that may execute a computer program stored in a Read-Only Memory (ROM) 1602 or loaded from a storage unit 1608 into a Random Access Memory (RAM) 1603 to perform various appropriate actions and processes. Various programs and data required for the operation of the device 1600 may also be stored in the RAM 1603. The computing unit 1601, the ROM 1602, and the RAM 1603 are connected to each other via a bus 1604. An Input/output (I/O) interface 1605 is also connected to the bus 1604.

A plurality of components of the device 1600 is connected to the I/O interface 1605. The plurality of components of the device 1600 includes: an input unit 1606, such as a keyboard, a mouse, etc.; an output unit 1607, such as various types of displays, speakers, etc.; a storage unit 1608, such as a disk, a CD-ROM, etc.; and a communication unit 1609, such as a network card, a modem, a wireless communications transceiver, etc. The communication unit 1609 allows the device 1600 to exchange information/data with other devices via a computer network such as the Internet and/or various telecommunication networks.

The computing unit 1601 may be a variety of general purpose and/or specialized processing components with processing and computing capabilities. Some examples of the computing unit 1601 comprise, but are not limited to, a Central Processing Unit (CPU), a Graphic Process Unit (GPU), various specialized Artificial Intelligence (AI) computing chips, various computing units that run machine learning model algorithms, Digital Signal Processing (DSP), and any appropriate processors, controllers, microcontrollers, etc. The computing unit 1601 performs the various methods and processes described above, such as the wireless audio data transmission method. For example, in some embodiments, the wireless audio data transmission method may be implemented as a computer software program that is tangibly contained in a machine-readable medium, such as the storage unit 1608. In some embodiments, some or all of the computer program may be loaded and/or installed on the device 1600 via the ROM 1602 and/or the communication unit 1609. When the computer program is loaded into the RAM 1603 and executed by the computing unit 1601, one or more operations of the wireless audio data transmission method described above may be performed. Alternatively, in other embodiments, the computing unit 1601 may be configured to perform the wireless audio data transmission method by any other appropriate means (e.g., with the aid of firmware).

Depending on the requirements, the master device may allocate any number of time slots in the current sub-event, any one of the time slots, to any of the slave devices, or may not allocate any of the time slots in the current sub-event to any slave device. Various embodiments of the systems and techniques described above herein can be found in digital electronic circuit systems, integrated circuit systems, Field-Programmable Gate Arrays (FPGAs), Application Specific Integrated Circuit, Field-Programmable Gate Array (FPGA), Application Specific Integrated Circuit (ASIC), Application Specific Standard Product (ASSP), System on Chip (SOC), Complex Programmable Logic Device (CPLD), Computer Hardware, Computer Software, and Computer Software. CPLD), computer hardware, firmware, software, and/or combinations thereof are implemented. These various embodiments may comprise: implementation in one or more computer programs that may be executed and/or interpreted on a programmable system comprising at least one programmable processor, which may be a dedicated or general-purpose programmable processor, that may receive data and instructions from the storage system, the at least one input device, and the at least one output device, and transmit the data and instructions to the storage system, the at least one input device, and the at least one output device. data and instructions to the storage system, the at least one input device, and the at least one output device.

Program code for implementing the methods of the present invention may be written in any combination of one or more programming languages. Such program code may be provided to a processor or controller of a general-purpose computer, a specialized computer, or other programmable data processing device such that the program code when executed by the processor or controller causes the functions/operations set forth in the flowchart and/or the block diagram to be implemented. The program code may be executed entirely on the machine, partially on the machine, partially on the machine as a stand-alone software package and partially on a remote machine or entirely on a remote machine or server.

In one embodiment, the present invention also provides a computer-readable storage medium having a computer program stored thereon. When the computer program is executed by a processor to realize the BLE broadcast communication method in the above-described embodiments and can achieve the same technical effect, which will not be repeated herein in order to avoid repetition. The computer-readable storage medium can be a read-only memory (ROM), random access memory (RAM), magnetic disc or optical disc, and etc.

The embodiments of this application are described above in conjunction with the accompanying drawings, but this application is not limited to the specific embodiments described above, the specific embodiments described above are merely illustrative and not limiting, and the person of ordinary skill in the field of this application, without departing from the purpose of the application and the scope of protection of the claims, may also make many forms, all of which are under the protection of this application.

Although preferred embodiments of the present invention have been described, additional changes and modifications to these embodiments may be made once the basic creative concepts are known to those skilled in the art. The appended claims are therefore intended to be interpreted to comprise preferred embodiments and all changes and modifications falling within the scope of this application. Obviously, a person skilled in the art may make various changes and variations to the application without departing from the spirit and scope of the application. Thus, if these modifications and variations of this application fall within the scope of the claims and their equivalent technologies, the application is also intended to comprise these changes and variations.

What is claimed is:

1. A wireless audio data transmission method applied to a master device communicating wirelessly with N slave devices in consecutive isochronous intervals based on N communication links respectively, the N slave devices comprising one or more audio input slave devices and/or one or more audio output slave devices, N being an integer greater than or equal to 2, one of consecutive isochronous intervals comprising a plurality of sub-events, one sub-event comprising a plurality of time slots for audio data transmission, comprising:
receiving an audio data packet transmitted by a first target device within at least one first time slot of a first sub-event, and/or, transmitting an audio data packet to a second target device within at least one second time slot of the first sub-event, wherein the first target device is one audio input slave device of the N slave devices and the second target device is one audio output slave device of the N slave devices;
transmitting a control packet to the N slave devices in an event of a failure to receive the audio data packet transmitted by the first target device in the first sub-event, and/or, in an event of a failure to transmit the audio data packet to the second target device, the control packet being configured to indicate at least one third time slot within a second sub-event in which the first target device is permitted to transmit the audio data packet to the master device through corresponding communication link, and/or at least one fourth time slot in the second sub-event in which the second target device is permitted to receive the audio data packet transmitted by the master device through corresponding communication link;
wherein the first sub-event and the second sub-event are different sub-events within one isochronous interval and the second sub-event is later than the first sub-event.

2. The method according to claim 1, wherein the number of the at least one third time slot is greater than the number of the at least one first time slot, and/or, the number of the at least one fourth time slot is greater than the number of the at least one second time slot,
the first time slot, the second time slot, the third time slot, and the fourth time slot are the time slots used for audio data transmission, a time slot distribution of the at least one first time slot in the first sub-event is different from a time slot distribution of the at least one third time slot in the second sub-event, and/or, a time slot distribution of the at least one second time slot in the first sub-event is different from a time slot distribution of the at least one fourth time slot in the second sub-event.

3. The method according to claim 1, wherein the isochronous intervals further comprise a bidirectional advertising communication time slot, wherein the master device periodically transmits a synchronization control data packet based on a periodic advertising channel in the bidirectional advertising communication time slot and receives a synchronization control response packet fed back by a candidate slave device which is one of the slave devices requesting access,
wherein the master device transmits a link random access command based on the synchronization control data packet and obtains a link access request fed back by the candidate slave device requesting access based on the received synchronization control response packet;
the master device determines, based on the link access request, that the candidate slave device requesting access is the audio input slave device or the audio output slave device;
the master device further transmits a link access permit command based on the synchronization control data packet for permitting the candidate slave device to establish a communication link with the master device.

4. The method according to claim 3, wherein when the master device transmits the link random access command based on the synchronization control data packet, the synchronization control data packet carries link information, the link information comprising at least one of:
a first link parameter for indicating a time offset of a starting moment of the synchronization control data packet from a starting moment of the isochronous intervals;
a second link parameter for indicating a duration of the isochronous interval;
a third link parameter for indicating a maximum number of the communication links allowed to be established;
a fourth link parameter for indicating a maximum number of the time slots for audio data transmission that may be allocated to the slave devices;
a fifth link parameter for indicating the number of sub-events comprised in one isochronous interval;
a sixth link parameter for indicating a time interval between two adjacent sub-events within one isochronous interval;
a seventh link parameter for indicating a maximum number of bytes of a payload of a protocol data unit corresponding to the master device;
an eighth link parameter for indicating a maximum number of bytes of a payload of a protocol data unit corresponding to the candidate slave device;
a ninth link parameter for indicating a channel mapping table; and
a tenth link parameter for indicating a link transmission rate.

5. The method according to claim 3, wherein when the master device transmits a link access permit command based on the synchronization control data packet, the synchronization control data packet carries control information, the control information comprising at least one of:
a first control parameter for indicating the number of the communication link which is allowed to access;
a second control parameter for indicating a direction of audio data transmission corresponding to the communication link which is allowed to access;
a third control parameter for indicating a channel type corresponding to the communication link which is allowed to access;
a fourth control parameter for indicating an effective time of the link access permit command;
a fifth control parameter for indicating a device address of the candidate slave device that is allowed to access; and
a sixth control parameter for indicating a maximum number of bytes of a payload of the protocol data unit corresponding to the candidate slave device that is allowed to access.

6. The method according to claim 3, wherein when the master device obtains the link access request fed back by the candidate slave device based on the received synchronization control response packet, the synchronization control response packet carries request information, the request information comprising:
a first request parameter for indicating a device address of the candidate slave device;
a second request parameter for indicating a direction of audio data transmission corresponding to the candidate slave device; and
a third request parameter for indicating a channel type corresponding to the candidate slave device.

7. The method according to claim 1, wherein the control packet comprises a link sequence, wherein the link sequence comprises at least one first element indicating the communication link corresponding to the first target device, and at least one second element indicating the communication link corresponding to the second target device;
an order of the at least one first element in the link sequence is configured to indicate the at least one third time slot within the second sub-event in which the first target device is permitted to transmit the audio data packet to the master device through corresponding communication link;
an order of the at least one second element in the link sequence is configured to indicate the at least one fourth time slot in the second sub-event in which the second target device is permitted to receive the audio data packet transmitted by the master device through corresponding communication link.

8. The method according to claim 1, wherein the control packet comprises a first sub-parameter and a second sub-parameter,
wherein the first sub-parameter is configured for indicating the third time slot or the fourth time slot in the second sub-event, and the second sub-parameter is configured for indicating a link number of the communication link corresponding to the first target device or a link number of the communication link corresponding to the second target device;
a value of the first sub-parameter is configured for indicating whether the third time slot or the fourth time slot corresponding to the first sub-parameter is enabled.

9. The method according to claim 8, wherein the control packet comprises a third sub-parameter and/or a fourth sub-parameter,
wherein the third sub-parameter is configured to indicate the number of the audio data packet corresponding to the first target device or the number of the audio data packet corresponding to the second target device, and the fourth sub-parameter is configured to indicate a direction of audio data transmission corresponding to the first target device or a direction of audio data transmission corresponding to the second target device.

10. The method according to claim 7, wherein the control packet further comprises: a first identification parameter and/or a second identification parameter;
wherein the first identification parameter is configured to indicate the number of communication links wirelessly communicating with the master device, and the second identification parameter is configured to indicate a sequence number of the second sub-event in corresponding isochronous interval; and/or
the control packet further comprises an acknowledgement link mapping table, the acknowledgement link mapping table is configured to indicate the communication link that is required to reply with an acknowledgement ACK.

11. The method according to claim 1, wherein the audio data packet comprises audio data and a preset parameter, wherein the preset parameter comprises at least one of:
a fifth sub-parameter for indicating a transmission direction of the audio data packet;
a sixth sub-parameter for indicating a link number of corresponding communication link;
a seventh sub-parameter for indicating the number of the audio data packet.

12. The method according to claim 1, wherein
when the master device successfully receives the audio data packet transmitted by the first target device in the first sub-event, the first target device is prohibited from transmitting the audio data packet to the master device through corresponding communication link in the second sub-event;
when the master device successfully transmits the audio data packet to the second target device in the first sub-event, the second target device is prohibited from receiving the audio data packet transmitted by the master device through corresponding communication link in the second sub-event.

13. A wireless audio data transmission method applied to a slave device communicating wirelessly with a master device in consecutive isochronous intervals based on a communication link, the slave device being an audio input slave device or an audio output slave device, one of consecutive isochronous intervals comprising a plurality of sub-events, one sub-event comprising a plurality of time slots for audio data transmission, comprising:
transmitting an audio data packet to the master device within at least one first time slot of a first sub-event when the slave device is the audio input slave device, or, receiving an audio data packet transmitted by the master device within at least one second time slot of the first sub-event when the slave device is an audio output slave device;
receiving a control packet transmitted by the master device, the control packet being configured to indicate at least one third time slot within a second sub-event in which the slave device is permitted to transmit the audio data packet to the master device through corresponding communication link, or, at least one fourth time slot in which the slave device is permitted to receive the audio data packet transmitted by the master device through corresponding communication link;
transmitting the audio data packet to the master device in the at least one third time slot of the second sub-event based on the control packet, or, receiving the audio data packet transmitted by the master device in the at least one fourth time slot of the second sub-event based on the control packet;
wherein the first sub-event and the second sub-event are different sub-events within the consecutive isochronous intervals and the second sub-event is later than the first sub-event.

14. The method according to claim 13, wherein the number of the at least one third time slot is greater than the number of the at least one first time slot, and/or, the number of the at least one fourth time slot is greater than the number of the at least one second time slot,
the first time slot, the second time slot, the third time slot, and the fourth time slot are the time slots used for the audio data transmission, a time slot distribution of the at least one first time slot in the first sub-event is different from a time slot distribution of the at least one third time slot in the second sub-event, and/or, a time slot distribution of the at least one second time slot in the first sub-event is different from a time slot distribution of the at least one fourth time slot in the second sub-event.

15. The method according to claim 13, wherein the isochronous interval further comprises a bidirectional advertising communication time slot, the method further comprising:
receiving, by the slave device, a synchronization control data packet transmitted by the master device based on a periodic advertising channel in the bidirectional advertising communication time slot and transmitting, by the slave device, a synchronization control response packet based on the synchronization control data packet to the master device on the periodic advertising channel when the slave device is a candidate slave device which is one of the slave devices requesting access to the master device,
wherein the slave device obtains a link random access command transmitted by the master device based on the synchronization control data packet, transmits a link access request to the master device via the synchronization control response packet, the link access request carries an indication that the slave device is the audio input slave device or the audio output slave device;
the slave device further obtains a link access permit command transmitted by the master device based on the synchronization control data packet and establishes the communication link with the master device based on the link access permit command.

16. The method according to claim 14, wherein when the slave device obtains a link random access command transmitted by the master device based on the synchronization control data packet, the synchronization control data packet carries link information, the link information comprising at least one of:
a first link parameter for indicating a time offset of a starting moment of the synchronization control data packet from a starting moment of the isochronous interval;
a second link parameter for indicating a duration of the isochronous interval;
a third link parameter for indicating a maximum number of the communication links allowed to be established;
a fourth link parameter for indicating a maximum number of the time slots for audio data transmission that may be allocated to the slave device;
a fifth link parameter for indicating the number of sub-events comprised in one isochronous interval;
a sixth link parameter for indicating a time interval between two adjacent sub-events within one isochronous interval;
a seventh link parameter for indicating a maximum number of bytes of a payload of a protocol data unit corresponding to the master device;
an eighth link parameter for indicating a maximum number of bytes of a payload of a protocol data unit corresponding to the candidate slave device;
a ninth link parameter for indicating a channel mapping table; and
a tenth link parameter for indicating a link transmission rate.

17. A wireless audio data transmission device used as a master device communicating wirelessly with N slave devices in consecutive isochronous intervals based on N communication links respectively, the N slave devices comprising one or more audio input slave devices and/or one or more audio output slave devices, N being an integer greater than or equal to 2, one of consecutive isochronous intervals comprising a plurality of sub-events, one sub-event comprising a plurality of time slots for audio data transmission, the wireless audio data transmission device comprising:
a first transmission module configured for receiving the audio data packet transmitted by a first target device within at least one first time slot of a first sub-event, and/or, transmitting the audio data packet to a second target device within at least one second time slot of the first sub-event, wherein the first target device is one audio input slave device of the N slave devices and the second target device is one audio output slave device of the N slave devices;
a control module configured for transmitting a control packet to the N slave devices in an event of a failure to receive the audio data packet transmitted by the first target device in the first sub-event, and/or, in an event of a failure to transmit the audio data packet to the second target device, the control packet being configured to indicate at least one third time slot within a second sub-event in which the first target device is permitted to transmit the audio data packet to the master device through corresponding communication link, and/or at least one fourth time slot in the second sub-event in which the second target device is permitted to receive the audio data packet transmitted by the master device through corresponding communication link;
wherein the first sub-event and the second sub-event are different sub-events within the consecutive isochronous intervals and the second sub-event is later than the first sub-event.

18. The device according to claim 17, wherein the number of the at least one third time slot is greater than the number of the at least one first time slot, and/or, the number of the at least one fourth time slot is greater than the number of the at least one second time slot,
the first time slot, the second time slot, the third time slot, and the fourth time slot are the time slots used for the audio data transmission, a time slot distribution of the at least one first time slot in the first sub-event is different from a time slot distribution of the at least one third time slot in the second sub-event, and/or, a time slot distribution of the at least one second time slot in the first sub-event is different from a time slot distribution of the at least one fourth time slot in the second sub-event.

19. A wireless audio data transmission method, comprising:
transmitting, by a master device communicating wirelessly with a plurality of slave devices in consecutive isochronous intervals based on a plurality of communication links respectively, a control packet to the plurality of slave devices in one sub-event, wherein one isochronous interval comprises a plurality of sub-events, one sub-event comprises a plurality of time slots for audio data transmission, the control packet comprises a block resource allocation table configured by the master device depending on requirement, the time slots in the sub-event are flexibly allocated to the slave devices according to the block resource allocation table of the control packet; and
transmitting one or more audio data packets or receiving one or more audio data packets on the time slots in the one sub-event according to the block resource allocation table of the control packet.

20. The method according to claim 19, wherein the master device configures the block resource allocation table in the control packet in a current sub-event according to success or failure condition that the one or more audio data packets transmitted by the slave devices before the current sub-event are received by the master device and/or success or failure condition that the one or more audio data packets transmitted by the master device before the current sub-event are received by the slave devices,
each time slots for audio data transmission in the sub-event can be flexibly allocated to each of the slave devices according to the block resource allocation table of the control packet.
